(19) United States
(12) Patent Application Publication
(10) Pub. No.: US 2026/0145953 A1
(43) Pub. Date: May 28, 2026

(54) AUTOMATIC METHOD FOR PRODUCING FLUORINE-CONTAINING CRYSTALLINE PRODUCT FROM HYDROFLUORIC ACID SOLUTION

(71) Applicant: Ming-Cheng LI, Taoyuan City (TW)

(72) Inventor: Ming-Cheng LI, Taoyuan City (TW)

(21) Appl. No.: 19/176,630

(22) Filed: Apr. 11, 2025

(30) Foreign Application Priority Data
Nov. 22, 2024 (TW) 113145163

(51) Int. Cl. C01B 33/10; B01D 9/00; C01F 7/54

(52) U.S. Cl. CPC C01B 33/10; B01D 9/0063; C01F 7/54; B01D 2009/0086

(57) ABSTRACT

Provided is an automatic method for producing a fluorine-containing crystalline product from a hydrofluoric acid solution, comprising: sensing the concentration of the hydrofluoric acid solution, and presetting a feeding flow rate; outputting a predetermined flow rate of the reaction solution by an automatic control module based on the concentration and the flow rate of the hydrofluoric acid solution and the concentration of the reaction solution; feeding the reaction solution and the hydrofluoric acid solution into the reaction area; sensing the in-situ fluoride ion concentration of the solution in the reaction area in real time, and controlling the feeding flow rate of the reaction solution in real time by the automatic control module; sensing the precipitation height of the fluorine-containing crystals in real time, and controlling whether to discharge the fluorine-containing crystals by the automatic control module. The method can be used to easily treat the hydrofluoric acid solution with a high concentration, accordingly obtaining sodium fluoroaluminate crystalline products or sodium fluorosilicate crystalline products with sand-like shape, low moisture content, and high sodium-to-aluminum ratio.

### CROSS-REFERENCE TO RELATED APPLICATION

Pursuant to 35 U.S.C. § 119 (a), this application claims the benefits of the priority to Taiwan Patent Application No. 113145163, filed on Nov. 22, 2024. The contents of the prior application are incorporated herein by its entirety.

### BACKGROUND OF THE INVENTION

### 1. Field of the Invention

The present invention is related to a system and a method for producing a fluorine-containing crystalline product, particularly to an automatic system and an automatic method for producing the fluorine-containing crystalline product (for example, sodium fluoroaluminate or sodium fluorosilicate) from a hydrofluoric acid solution.

### 2. Description of the Prior Arts

Hydrofluoric acid (HF) is often used to remove inorganic metal ion impurities in the manufacturing process of high-tech industry for cleaning. Especially, the hydrofluoric acid solution is used for etching silicon dioxide in the wafer wet etching and cleaning process in semiconductor manufacturing industry, resulting in generation of high concentration wastewater containing hydrofluoric acid. If not properly treated or recycled, the wastewater may cause severe impact on the environment and the water ecosystem, going against the sustainable development of the environment.

The conventional treatment method mainly involves chemical coagulation and precipitation of hydrofluoric acid wastewater using slaked lime or calcium chloride, as well as precipitation with poly aluminum chloride (PAC) coagulants. However, the treatment method may produce a large amount of waste calcium fluoride sludge, which is unable to be effectively reused, resulting in a waste of resources.

Therefore, in recent years the industry has been actively researching on how to effectively recycle hydrofluoric acid waste solutions and convert them into reusable fluorine-containing products. Sodium hydroxide or sodium carbonate has been used to react with a high concentration hydrofluoric acid waste solution, forming sodium fluoride to reduce the concentration of fluoride ions, and then sodium aluminate agents are added with the addition of sodium hydroxide to control the pH value of the reaction. Such method is complicated and difficult to control, and the generated sodium fluoroaluminate powders have a high moisture content (more than 30%), so it needs to be separated by a plate filter press process for solid-liquid separation, and the subsequent steps are also relatively burdensome.

In another conventional method, a high concentration hydrofluoric acid waste solution (40 gram/liter [g/L] or above) reacts with sodium carbonate to form sodium fluoride, and a low concentration hydrofluoric acid waste solution (about 10 g/L) is first obtained after solid-liquid separation. After that, sodium aluminate is added for the secondary crystallization to obtain sodium fluoroaluminate powder. The method also has disadvantages of complicated manufacturing processes, high moisture content of sodium fluoroaluminate powder, high cost of energy consumption in the dehydration and drying process, and the final crystalline products are in powder form with a low sodium-to-aluminum molecular ratio, resulting in a low reuse value of sodium fluoroaluminate, against the recycling of fluorine-containing materials.

In view of this, it is still necessary to develop a more effective automatic technique for producing sodium fluoroaluminate, so as to solve the shortcomings of prior arts and meet current global expectations for sustainable development and efficient reuse of resources.

### SUMMARY OF THE INVENTION

One objective of the present invention is to effectively reuse hydrofluoric acid solution with a high concentration, and to obtain a fluorine-containing crystalline product with high economic value (such as sodium fluoroaluminate [cryolite] or sodium fluorosilicate) through a simple and easy-to-control production process.

In order to achieve the aforementioned objective, the present invention further provides an automatic method for producing the fluorine-containing crystalline product from the hydrofluoric acid solution, comprising:
providing the hydrofluoric acid solution and a reaction solution with a predetermined concentration, wherein the reaction solution is an aluminate solution or a silicate solution;
sensing a fluoride ion concentration of the hydrofluoric acid solution and presetting a feeding flow rate of the hydrofluoric acid solution;
outputting a predetermined flow rate of the reaction solution by an automatic control module based on the fluoride ion concentration and the feeding flow rate of the hydrofluoric acid solution and the predetermined concentration of the reaction solution;
feeding the reaction solution into a reaction area at the predetermined flow rate, and feeding the hydrofluoric acid solution into the reaction area at the feeding flow rate, so as to perform a crystallization reaction and form a mixed solution in the reaction area;
sensing a fluoride ion concentration of the mixed solution in the reaction area in real time while feeding the reaction solution and the hydrofluoric acid solution, receiving an in-situ parameter of the fluoride ion concentration of the mixed solution in the reaction area by the automatic control module, and controlling a feeding flow rate of the reaction solution in real time by the automatic control module under conditions that:
   when the in-situ parameter of the fluoride ion concentration received by the automatic control module falls within a range of a targeted crystal nucleation concentration ±5%, the feeding flow rate of the reaction solution is controlled to be equal to the predetermined flow rate of the reaction solution;
   when the in-situ parameter of the fluoride ion concentration is higher than 5% above the targeted crystal nucleation concentration, the feeding flow rate of the reaction solution is controlled to be greater than the predetermined flow rate of the reaction solution; and
   when the in-situ parameter of the fluoride ion concentration is lower than 5% below the targeted crystal nucleation concentration, the feeding flow rate of the reaction solution is controlled to be less than the predetermined flow rate of the reaction solution;
sensing multiple fluorine-containing crystals produced by the crystallization reaction and precipitated to a crystal collection area in real time, and controlling whether to discharge a solution comprising the fluorine-containing crystals by the automatic control module based on whether the fluorine-containing crystals reach a predetermined height; and
collecting the fluorine-containing crystalline product from a solution comprising the fluorine-containing crystals.

By technical means of sensing the in-situ fluoride ion concentration of the mixed solution in the reaction area and controlling the feeding flow rate of the reaction solution in real time, it is helpful for maintaining the fluoride ion concentration of the mixed solution in the reaction area within a favorable range of the targeted crystal nucleation concentration as much as possible during the process of inducing the crystallization reaction. Therefore, the hydrofluoric acid solution with a high concentration can be treated and regenerated into the fluorine-containing crystalline product by the simple automatic method in the present invention, thereby obtaining a sodium fluoroaluminate crystalline product or a sodium fluorosilicate crystalline product with sand-like shape, low moisture content (20% or below), and high sodium-to-aluminum molecular ratio (2.6 or above). In addition, compared with the conventional treatment, the method of the present invention can omit the complicated processes such as pH control, plate filter press treatment, and two-stage crystallization steps, and thus increase the economic value of recycling and reusing fluorine-containing materials.

Optionally, the concentration of the hydrofluoric acid solution may be 10 g/L to 400 g/L, but is not limited thereto. The hydrofluoric acid solution may be a hydrofluoric acid waste solution, thereby producing the fluoroaluminate crystalline product or the sodium fluorosilicate crystalline product with economic value through recycling and reusing the fluoride ion in the hydrofluoric acid waste solution. Herein, the hydrofluoric acid solution May comprise other components such as hydrochloric acid, nitric acid, and sulfuric acid, wherein the components may exist alone or be combined in the hydrofluoric acid solution, but are not limited thereto. Optionally, the hydrofluoric acid solution may include hydrochloric acid in a concentration of 0 volume % (vol %) to 20 vol % of the hydrofluoric acid solution, nitric acid in a concentration of 0 vol % to 50 vol %, and/or sulfuric acid in a concentration of 0 vol % to 60 vol %, but is not limited thereto. In one of the embodiments, the hydrofluoric acid solution may comprise hydrochloric acid in a concentration of 0.1 vol % to 15 vol % and nitric acid in a concentration of 0.1 vol % to 30 vol %. In another embodiment, the hydrofluoric acid solution may comprise hydrochloric acid in a concentration of 0.1 vol % to 10 vol %, nitric acid in a concentration of 0.1 vol % to 20 vol %, and sulfuric acid in a concentration of 0.1 vol % to 30 vol %. In another embodiment, the hydrofluoric acid solution may comprise hydrochloric acid in a concentration of 0.1 vol % to 20 vol %.

Optionally, the aluminate solution as the reaction solution comprises a sodium aluminate solution, an aluminum sulfate solution containing a sodium source, a polyaluminum chloride solution containing a sodium source, or a combination thereof, wherein the sodium source comprises sodium hydroxide, sodium chloride, sodium nitrate, or any combinations thereof. Optionally, the silicate solution as the reaction solution comprises a sodium silicate solution, but is not limited thereto.

Optionally, the automatic method comprises: sensing a turbidity of a confluence area in real time, and receiving an in-situ turbidity parameter and controlling a flow rate of a carrier-containing solution in the confluence area guided to the reaction area in real time based on the in-situ turbidity parameter by the automatic control module, thereby controlling the upflow velocity of the carrier-containing solution in the confluence area, wherein the confluence area is located between and interconnected with the reaction area and the crystal collection area. In the automatic method for producing sodium fluoroaluminate of the present invention, when the in-situ turbidity parameter received by the automatic control module is higher than 100 NTU, the upflow velocity of the carrier-containing solution in the confluence area controlled by the automatic control module is 0.4 centimeter/second (cm/s) to 0.6 cm/s, and when the in-situ turbidity parameter received by the automatic control module is lower than 100 NTU, the upflow velocity of the carrier-containing solution in the confluence area controlled by the automatic control module is 2.2 cm/s to 2.6 cm/s. Optionally, the upflow velocity of the carrier-containing solution in the confluence area may be increased by the automatic control module at an increasing rate of 0.25 cm/s to 0.75 cm/s per minute. According to the present invention, the confluence area comprises the mixed solution derived from the reaction area and the carrier-containing solution. When the crystals are formed to be quicksand-like, the settling rate of the solid particles due to gravity is greater than the upflow velocity of the carrier-containing solution in the confluence area, such that the crystals in the confluence area can flow along a settling funnel through a settling outlet and precipitate to the crystal collection area by gravity.

In the automatic method for producing the fluorine-containing crystalline product from the hydrofluoric acid solution of the present invention, the feeding flow rate of the reaction solution may be adjusted according to the following control conditions. For example, when the in-situ parameter of the fluoride ion concentration of the mixed solution in the reaction area received by the automatic control module is 5% to 10% above the targeted crystal nucleation concentration, the feeding flow rate of the reaction solution is controlled by the automatic control module to be 1.5% to 2.5% above the predetermined flow rate of the reaction solution; when the in-situ parameter of the fluoride ion concentration of the mixed solution in the reaction area received by the automatic control module is 5% to 10% below the targeted crystal nucleation concentration, the feeding flow rate of the reaction solution is controlled by the automatic control module to be 1.5% to 2.5% below the predetermined flow rate of the reaction solution; when the in-situ parameter of the fluoride ion concentration of the mixed solution in the reaction area received by the automatic control module is 10% to 20% above the targeted crystal nucleation concentration, the feeding flow rate of the reaction solution is controlled by the automatic control module to be 3.5% to 4.5% above the predetermined flow rate of the reaction solution; when the in-situ parameter of the fluoride ion concentration of the mixed solution in the reaction area received by the automatic control module is 10% to 20% below the targeted crystal nucleation concentration, the feeding flow rate of the reaction solution is controlled by the automatic control module to be 3.5% to 4.5% below the predetermined flow rate of the reaction solution; when the in-situ parameter of the fluoride ion concentration of the mixed solution in the reaction area received by the automatic control module is 20% to 30% above the targeted crystal nucleation concentration, the feeding flow rate of the reaction solution is controlled by the automatic control module to be 7.5% to 8.5% above the predetermined flow rate of the reaction solution; when the in-situ parameter of the fluoride ion concentration of the mixed solution in the reaction area received by the automatic control module is 20% to 30% below the targeted crystal nucleation concentration, the feeding flow rate of the reaction solution is controlled by the automatic control module to be 7.5% to 8.5% below the predetermined flow rate of the reaction solution; when the in-situ parameter of the fluoride ion concentration of the mixed solution in the reaction area received by the automatic control module is higher than 30% above the targeted crystal nucleation concentration, the feeding flow rate of the reaction solution is controlled by the automatic control module to be 14.5% to 15.5% above the predetermined flow rate of the reaction solution; when the in-situ parameter of the fluoride ion concentration of the mixed solution in the reaction area received by the automatic control module is lower than 30% below the targeted crystal nucleation concentration, the feeding flow rate of the reaction solution is controlled by the automatic control module to be at least 14.5% to 15.5% below the predetermined flow rate of the reaction solution.

In one of the embodiments of the present invention, when the reaction solution is the aluminate solution and the fluorine-containing crystalline product is the sodium fluoroaluminate crystalline product, a predetermined flow rate of the aluminate solution is output by the automatic control module according to the calculation that a ratio of the aluminum ion concentration of the aluminate solution to the fluoride ion concentration of the hydrofluoric acid solution is 1:6 to 1.20:6, which is converted from the aluminum-to-fluorine ratio of the sodium fluoroaluminate crystalline product. In one of the embodiments, the predetermined flow rate of the aluminate solution is output by the automatic control module according to the calculation that a ratio of the aluminum ion concentration of the aluminate solution to the fluoride ion concentration of the hydrofluoric acid solution is 1:6 to 1.05:6, which is converted from the aluminum-to-fluorine ratio of the sodium fluoroaluminate crystalline product. In another embodiment of the present invention, when the reaction solution is the silicate solution and the fluorine-containing crystalline product is the sodium fluorosilicate crystalline product, a predetermined flow rate of the sodium silicate solution is output by the automatic control module according to the calculation that the silicon ion concentration of the sodium silicate solution to the fluoride ion concentration of the hydrofluoric acid solution is 1:6 to 1.20:6, which is converted from the silicon-to-fluorine ratio of the sodium fluorosilicate crystalline product.

Optionally, the targeted crystal nucleation concentration may be 1000 parts per million (ppm) to 12000 ppm. In one of the embodiments, the targeted crystal nucleation concentration may be 1000 ppm to 9500 ppm. In another embodiment, the targeted crystal nucleation concentration may be 1500 ppm to 12000 ppm.

In the automatic method for producing the sodium fluoroaluminate crystalline product from the hydrofluoric acid solution of the present invention, the fluoride ion concentration may be controlled to be 1000 ppm to 9500 ppm by the targeted crystal nucleation concentration of forming sodium fluoroaluminate from the crystallization reaction of the hydrofluoric acid solution and the aluminate solution. Specifically, the fluoride ion concentration may be controlled to be 1000 ppm to 2500 ppm, but is not limited thereto. A person skilled in the art can calculate a solubility product constant (Ksp: 1.98×10⁻⁵) based on a targeted particle size and a solubility (5.6 g/L) of the sodium fluoroaluminate crystalline product and make corresponding adjustments to a targeted concentration. For example, when the ratio of magnification of the aluminum ion concentration in the aluminate solution and the targeted crystal nucleation concentration relative to Ksp (the ratio of [Al][F]³ product relative to Ksp) is about 200 to 600, the targeted particle size of the sodium fluoroaluminate crystalline product may be controlled to be 200 mesh to 325 mesh, and the targeted crystal nucleation concentration may be 1000 ppm to 4500 ppm; when the ratio of [Al][F]³ product relative to Ksp is about 1800 to 2200, the targeted particle size of the sodium fluoroaluminate crystalline product may be controlled to be 400 mesh, and the targeted crystal nucleation concentration may be 3000 ppm to 7000 ppm; when the ratio of [Al][F]³ product relative to Ksp is about 4500 to 5500, the targeted particle size of the sodium fluoroaluminate crystalline product may be controlled to be 600 mesh, and the targeted crystal nucleation concentration may be 3500 ppm to 9500 ppm. For ease in understanding, the conditions that can be set for the targeted crystal nucleation concentration according to the aluminum ion concentration in the aluminate solution, the ratio of [Al][F]³ product relative to Ksp, and the targeted particle size are listed in the table below, but are not limited thereto.

| | | Targeted | |
|---|---|---|---|
| | | particle | |
| | | size of | Targeted |
| Aluminum ion | | the sodium | crystal |
| concentration in | Ratio of [Al][F]³ | fluoroaluminate | nucleation |
| the aluminate | product relative | crystalline | concentration |
| solution (g/L) | to Ksp | product (mesh) | (ppm) |
| 25 | 200 | 200 | 3100 |
| | 600 | 325 | 4400 |
| | 2000 | 400 | 6600 |
| | 5000 | 600 | 9000 |
| 82 | 200 | 200 | 2000 |
| | 600 | 325 | 3000 |
| | 2000 | 400 | 4400 |
| | 5000 | 600 | 6000 |
| 260 | 200 | 200 | 1400 |
| | 600 | 325 | 2000 |
| | 2000 | 400 | 3000 |
| | 5000 | 600 | 4000 |

In the automatic method for producing the sodium fluorosilicate crystalline product from the hydrofluoric acid solution of the present invention, the fluoride ion concentration may be controlled to be 1500 ppm to 12000 ppm by the targeted crystal nucleation concentration of forming sodium fluorosilicate from the crystallization reaction of the hydrofluoric acid solution and the silicate solution. Specifically, the fluoride ion concentration may be controlled to be 1000 ppm to 2500 ppm, but is not limited thereto. A person skilled in the art can calculate a solubility product constant (Ksp: 7.14×10⁻⁵) based on a targeted particle size and a solubility (7.8 g/L) of the sodium fluorosilicate crystalline product and make corresponding adjustments to a targeted concentration. For example, when the ratio of magnification of the silicon ion concentration in the silicate solution and the targeted crystal nucleation concentration relative to Ksp (the ratio of [Si][F]⁶ product relative to Ksp) is about 100 to 400, the targeted particle size of the sodium fluorosilicate crystalline product may be controlled to be 140 mesh to 200 mesh, and the targeted crystal nucleation concentration may be 1500 ppm to 6000 ppm; when the ratio of [Si][F]⁶ product relative to Ksp is about 1000 to 4000, the targeted particle size of the sodium fluorosilicate crystalline product may be controlled to be 325 mesh to 400 mesh, and the targeted crystal nucleation concentration may be 3000 ppm to 12000 ppm. For ease in understanding, the conditions that can be set for the targeted crystal nucleation concentration according to the silicon ion concentration in the silicate solution, the ratio of [Si][F]⁶ product relative to Ksp, and the targeted particle size are listed in the table below, but are not limited thereto

| | | Targeted | |
|---|---|---|---|
| | | particle | |
| | | size of | Targeted |
| Silicon ion | | the sodium | crystal |
| concentration in | Ratio of [Si][F]⁶ | fluorosilicate | nucleation |
| the silicate | product relative | crystalline | concentration |
| solution (g/L) | to Ksp | product (mesh) | (ppm) |
| 30 | 100 | 140 | 3600 |
| | 400 | 200 | 5600 |
| | 1000 | 325 | 7500 |
| | 4000 | 400 | 12000 |
| 160 | 100 | 140 | 2000 |
| | 400 | 200 | 3200 |
| | 1000 | 325 | 4400 |
| | 4000 | 400 | 6900 |
| 320 | 100 | 140 | 1600 |
| | 400 | 200 | 2500 |
| | 1000 | 325 | 3500 |
| | 4000 | 400 | 5500 |

On the other hand, in the automatic method for producing the fluorine-containing crystalline product from the automatic system of the present invention, when the in-situ parameter of the fluoride ion concentration of the mixed solution in the reaction area received by the automatic control module is lower than the limit concentration, the feeding flow rate of the reaction solution is controlled by the automatic control module to be 0, and the limit concentration is 500 ppm to 1000 ppm, but are not limited thereto. A person skilled in the art can make corresponding adjustments to the targeted crystal nucleation concentration according to the sodium-to-aluminum molecular ratio of sodium fluoroaluminate produced after the reaction.

Optionally, the automatic method may comprise feeding water or a recycled carrier-containing solution into the reaction area in advance, feeding the reaction solution into the reaction area at the predetermined flow rate, and then feeding the hydrofluoric acid solution into the reaction area at the feeding flow rate.

The aforementioned step of collecting the fluorine-containing crystalline product from the solution comprising the fluorine-containing crystals comprises: centrifuging the solution comprising the fluorine-containing crystals to collect the fluorine-containing crystalline product therefrom.

Optionally, feed the reaction solution into the reaction area by spraying, and feed the hydrofluoric acid solution into the reaction area by spraying, wherein the reaction solution and the hydrofluoric acid solution are each independently sprayed into the shape of a sector, hollow cone, solid cone, spiral, or cylinder, in order to increase reaction contact area of the hydrofluoric acid solution and the reaction solution. Preferably, one of the reaction solution and the hydrofluoric acid solution is sprayed into the shape of a sector or a solid cone and fed into an upper part of the reaction area, and the other of the reaction solution and the hydrofluoric acid solution is sprayed into the shape of a hollow cone or a spiral and fed into a lower part of the reaction area. Besides, the carrier-containing solution may also be guided to the reaction area by spraying, and the carrier-containing solution is sprayed into the shape of a sector, hollow cone, solid cone, spiral, or cylinder, but are not limited thereto.

Optionally, in the automatic method, additionally stir the mixed solution in the reaction area at the stirring speed of 40 revolutions per minute (rpm) to 120 rpm.

In order to achieve the aforementioned objective, the present invention provides an automatic system for producing the fluorine-containing crystalline product from the hydrofluoric acid solution, comprising:
a crystallization device, including an outer tank, an inner tank, a settling funnel, a crystal outlet, a fluoride ion concentration sensor, and an optical fiber sensor, wherein the inner tank is positioned inside the outer tank, and the inner tank is formed with a flowing outlet; the settling funnel is positioned inside of the outer tank and under the inner tank, the crystal outlet is formed at the bottom of the outer tank, and the crystallization device has a reaction area, a confluence area, and a crystal collection area interconnected with each other; the reaction area is defined by the inner tank; the confluence area is located outside the inner tank, inside the outer tank, and above the settling funnel; the crystal collection area is located inside the outer tank and below the settling funnel; the fluoride ion concentration sensor is disposed on the outer tank and a sensing end of the fluoride ion concentration sensor extends to the reaction area; the optical fiber sensor is disposed below the settling funnel and above the crystal outlet;
a first feeding module, including a first feeding tank, a first feeding tube, and a first pump, wherein the first feeding tank of the first feeding module is connected with the inner tank through the first feeding tube, and the first pump is disposed between the upstream side and the downstream side of the first feeding tube;
a second feeding module, including a second feeding tank, a second feeding tube, and a second pump, wherein the second feeding tank of the second feeding module is connected with the inner tank through the second feeding tube, and the second pump is disposed between the upstream side and the downstream side of the second feeding tube;
a crystal treatment module, including a discharging tube and a discharging pump, wherein the upstream side of the discharging tube is connected with the crystal outlet, and the discharging pump is disposed between the upstream side and the downstream side of the discharging tube; and
an automatic control module electrically connected to the fluoride ion concentration sensor, the optical fiber sensor, the first pump, the second pump, and the discharging pump, wherein the automatic control module receives an in-situ parameter of the fluoride ion concentration from the fluoride ion concentration sensor to control the first pump or the second pump, and the automatic control module receives a detected result from the optical fiber sensor to control opening and closing of the discharging pump.

With the configuration that the automatic control module is electrically connected to the fluoride ion concentration sensor, the optical fiber sensor, the first pump, the second pump, and the discharging pump, and that the first pump, the second pump, and the discharging pump are controlled by the automatic control module based on the in-situ parameter of the fluoride ion concentration and the detection result of the optical fiber sensor, it is helpful for maintaining the fluoride ion concentration of the mixed solution in the reaction area within a favorable range of the targeted crystal nucleation concentration as much as possible during the process of inducing the crystallization reaction, so the automatic system of the present invention can simplify and control reactions and processes in the production of the fluorine-containing crystalline product.

Optionally, the automatic system may comprise a carrier circulation module, which includes a drain tube and a supply pump, the carrier circulation module is connected with the inner tank of the crystallization device through the drain tube, the drain tube comprises a suction end and a supply end opposite to each other, the suction end extends to the confluence area, the supply end extends to the reaction area, and the supply pump is disposed between the suction end and the supply end of the drain tube. Accordingly, the carrier circulation module is helpful for guiding the crystal nucleus of the confluence area into the reaction area of the inner tank for reaction, thereby collecting the fluorine-containing crystalline product with the targeted particle size and uniformity.

Besides, the automatic system may comprise a turbidity sensor disposed on the outer tank, and the sensing end thereof extends to the confluence area; moreover, the automatic control module is electrically connected to the supply pump and the turbidity sensor, and the automatic control module controls the supply pump of the carrier circulation module based on the detected in-situ turbidity parameter from the turbidity sensor.

In one of the embodiments, the first feeding module comprises multiple spray nozzles disposed on the downstream side of the first feeding tube; the second feeding module comprises multiple spray nozzles disposed on the downstream side of the second feeding tube, and the spray nozzles of the first feeding module and the spray nozzles of the second feeding module are positioned inside the inner tank. Herein, the spray nozzles of the second feeding tube are disposed above the spray nozzles of the first feeding tube, and openings of the spray nozzles of the second feeding module are disposed towards openings of the spray nozzles of the first feeding module. Preferably, the height of the spray nozzles of the first feeding module may be lower than the level of the flowing outlet, and a spray element is disposed on the supply end of the drain tube.

Optionally, the settling funnel is formed with a settling outlet, the crystallization device comprises a guiding board below the settling outlet, and the guiding board is formed inclined from a side of an inner wall of the outer tank near the crystal outlet to an opposite side of the crystal outlet. In addition, the crystallization device comprises an overflow outlet near the top of the outer tank.

Besides, the automatic system may comprise a stirring unit additionally, and the stirring unit is disposed on the inner tank and extends to the reaction area to evenly stir the mixed solution in the reaction area.

Optionally, the crystal treatment module comprises a centrifuge device, and the centrifuge device is connected with the downstream side of the discharging pump. Besides, the centrifuge device may further be connected with a product collection tank to collect the centrifuged product from the centrifuge device.

Preferably, the automatic method for producing the fluorine-containing crystalline product from the hydrofluoric acid solution in the present invention may be performed with any automatic equipment for producing the fluorine-containing crystalline product from the hydrofluoric acid solution in the aforementioned embodiments.

### BRIEF DESCRIPTION OF THE DRAWINGS

FIG. 1 is the schematic diagram of the automatic system for producing the fluorine-containing crystalline product from the hydrofluoric acid solution.

FIG. 2 is the flow chart of the automatic method for producing the fluorine-containing crystalline product from the hydrofluoric acid solution;

FIG. 3 is the schematic diagram of the automatic production process using an automatic system at initial stage;

FIG. 4 is the schematic diagram of carrying out the automatic production process for a while using the automatic system;

FIG. 5A is the line graph of the feeding flow rate of the sodium aluminate solution, which is controlled by the automatic control module according to the in-situ parameter of the fluoride ion concentration, over reaction time in the automatic method of example 1;

FIG. 5B is the line graph of the upflow velocity of the solution containing the self-assembled carrier, which is controlled by the automatic control module according to the in-situ turbidity parameter, over reaction time in the automatic method of example 1;

FIG. 6A is the line graph of the feeding flow rate of the aluminum sulfate solution containing sodium chloride, which is controlled by the automatic control module according to the in-situ parameter of the fluoride ion concentration, over reaction time in the automatic method of example 2;

FIG. 6B is the line graph of the upflow velocity of the solution containing the self-assembled carrier, which is controlled by the automatic control module according to the in-situ turbidity parameter, over reaction time in the automatic method of example 2;

FIG. 7A is the line graph of the feeding flow rate of the sodium aluminate solution, which is controlled by the automatic control module according to the in-situ parameter of the fluoride ion concentration, over reaction time in the automatic method of example 3;

FIG. 7B is the line graph of the upflow velocity of the solution containing the self-assembled carrier, which is controlled by the automatic control module according to the in-situ turbidity parameter, over reaction time in the automatic method of example 3;

FIGS. 8A and 8B are the SEM images of the sodium fluoroaluminate crystalline product of example 1;

FIGS. 8C and 8D are the SEM images of the sodium fluoroaluminate crystalline product of example 2;

FIGS. 8E and 8F are the SEM images of the sodium fluoroaluminate crystalline product of example 3;

FIG. 9 is the XRD image of the sodium fluoroaluminate crystalline products and the sodium fluoroaluminate standard samples of examples 1 to 3;

FIG. 10A is the line graph of the feeding flow rate of the sodium silicate solution, which is controlled by the automatic control module according to the in-situ parameter of the fluoride ion concentration, over reaction time in the automatic method of example 4;

FIG. 10B is the line graph of the upflow velocity of the solution containing the self-assembled carrier, which is controlled by the automatic control module according to the in-situ turbidity parameter, over reaction time in the automatic method of example 4;

FIGS. 11A and 11B are the SEM images of the sodium fluorosilicate crystalline product of example 4; and

FIG. 12 is the XRD image of the sodium fluorosilicate crystalline product and the sodium fluorosilicate standard sample of example 4.

### DETAILED DESCRIPTION OF THE PREFERRED EMBODIMENTS

The implementation of the automatic system and method for producing the fluorine-containing crystalline product are illustrated below with figures. A person skilled in the art can easily realize the advantages and effects of the present invention from the following examples and comparative examples. Various modifications and variations could be made in order to practice or apply the present invention without departing from the spirit and scope of the present application.

Automatic System for Producing the Fluorine-Containing Crystalline Product from Hydrofluoric Acid Solution

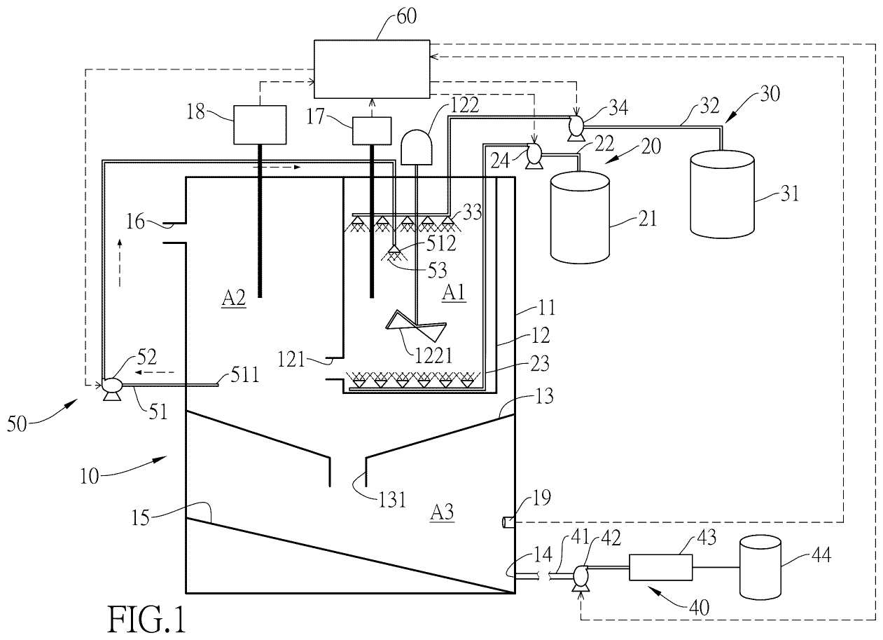

As shown in FIG. 1, the automatic system for producing the fluorine-containing crystalline product in the present invention comprises: a crystallization device 10, a first feeding module 20, a second feeding module 30, a crystal treatment module 40, a carrier circulation module 50, and an automatic control module 60.

The crystallization device 10 includes an outer tank 11, an inner tank 12, a settling funnel 13, a crystal outlet 14, a guiding board 15, an overflow outlet 16, a fluoride ion concentration sensor 17, a turbidity sensor 18, and an optical fiber sensor 19. The inner tank 12 is positioned inside of the outer tank 11, and the inner tank 12 is formed with a flowing outlet 121 and has a stirring unit 122. The settling funnel 13 is positioned inside of the outer tank 11 and under the inner tank 12, the upper edge of the settling funnel 13 clings to the inner wall of the outer tank 11, and the lower edge of the settling funnel 13 tapers toward the center of the outer tank 11 and is formed with a settling outlet 131. The crystal outlet 14 is formed near the bottom of the outer tank 11. The guiding board 15 is positioned below the settling outlet 131, and the guiding board 15 is formed inclined from a side of a inner wall of the outer tank 11 near the crystal outlet 14 to an opposite side of the crystal outlet 14. The overflow outlet 16 is formed near the top of the outer tank 11.

According to the aforementioned structural design, the crystallization device 10 can be divided into a reaction area A1, a confluence area A2, and a crystal collection area A3. The reaction area A1 is defined by the inner tank 12 and located inside the inner tank 12. The confluence area A2 is located outside the inner tank 12, inside the outer tank 11, and above the settling funnel 13. The crystal collection area A3 is located inside the outer tank 11 and below the settling funnel 13. The reaction area A1, the confluence area A2, and the crystal collection area A3 are connected with each other.

In addition, in the crystallization device 10, the fluoride ion concentration sensor 17 is disposed on the inner tank 12, and a sensing end of the fluoride ion concentration sensor 17 extends to the reaction area A1 to detect the fluoride ion concentration of the mixed solution in the reaction area A1 in real time. The turbidity sensor 18 is disposed on the outer tank 11, and a sensing end of the turbidity sensor 18 extends to the confluence area A2 to detect the turbidity of the solution in the confluence area A2 in real time. The optical fiber sensor 19 is disposed on the outer tank 11 and located below the settling funnel 13 and above the crystal outlet 14 to detect whether the crystals precipitated to the crystal collection area A3 have reached the predetermined level corresponding to the optical fiber sensor 19.

The first feeding module 20 is connected with the crystallization device 10 to feed materials to the crystals of the inner tank 12 of the crystallization device 10 in a first feeding tank 21 able to accommodate the hydrofluoric acid solution or the reaction solution. The upstream side of a first feeding tube 22 is connected with the first feeding tank 21, and the downstream side of the first feeding tube 22 is positioned inside of the inner tank 12 of the crystallization device 10 and can extend to the lower part of the inner tank 12. Multiple spray nozzles 23 are disposed on the downstream side of the first feeding tube 22 and connected with the first feeding tube 22, and openings of the spray nozzles 23 are disposed towards top of the inner tank 12, wherein height of the spray nozzles 23 can be lower than the level of the flowing outlet 121 of the inner tank 12. A first pump 24 is connected with the first feeding tube 22 and disposed between the upstream side and the downstream side of the first feeding tube 22.

The second feeding module 30 is connected with the crystallization device 10, and the second feeding module 30 is also used to feed materials to the crystals of the inner tank 12 of the crystallization device 10, wherein the second feeding module 30 includes a second feeding tank 31, a second feeding tube 32, multiple spray nozzles 33, and a second pump 34. The second feeding tank 31 can accommodate the other of the hydrofluoric acid solution or the reaction solution. The upstream side of the second feeding tube 32 is connected with the second feeding tank 31, and the downstream side of the second feeding tube 32 is set inside of the inner tank 12 of the crystallization device 10 and can extend to the upper part of the inner tank 12. The spray nozzles 33 are disposed below the downstream side of the second feeding tube 32 and connected with the second feeding tube 32, and openings of the spray nozzles 33 in the second feeding module 30 are disposed towards the bottom of the inner tank 12, i.e., the openings of the spray nozzles 33 in the second feeding module 30 can be oriented towards the openings of the spray nozzles 23 in the first feeding module 20, and height of the spray nozzles 33 can be higher than the level of the flowing outlet 121. The second pump 34 is connected with the second feeding tube 32 and disposed between the upstream side and the downstream side of the second feeding tube 32. In addition, the aforementioned stirring unit 122 disposed on the inner tank 12 has multiple blades 1221, and the blades 1221 can be located between the spray nozzles 23 in the first feeding module 20 and the spray nozzles 33 in the second feeding module 30.

The crystal treatment module 40 is connected with the crystallization device 10 to receive the fluorine-containing crystals discharged from the crystal outlet 14 of the crystallization device 10, obtaining targeted fluorine-containing crystalline products (for example, sodium fluoroaluminate crystalline products or sodium fluorosilicate crystalline products) after subsequent treatment, wherein the crystal treatment module 40 has a discharging tube 41, a discharging pump 42, a centrifuge device 43, and a product collection tank 44. The upstream side of the discharging tube 41 of the crystal treatment module 40 is connected with the crystal outlet 14 of the crystallization device 10. The discharging pump 42 is disposed on the discharging tube 41 and between the upstream side and the downstream side of the discharging tube 41. The centrifuge device 43 is connected with the downstream side of the discharging tube 41. The product collection tank 44 is connected with the centrifuge device 43 to obtain the fluorine-containing crystalline product collected from the centrifuge device 43.

The carrier circulation module 50 is connected with the inner tank 12 of the crystallization device 10 and has a drain tube 51, a supply pump 52, and a spray element 53. The drain tube 51 has a suction end 511 and a supply end 512 opposite to each other, wherein the suction end 511 extends to the confluence area A2, and the supply end 512 extends to the reaction area A1. The supply pump 52 is disposed on the drain tube 51 and between the suction end 511 and the supply end 512 of the drain tube 51. The spray element 53 is disposed on the supply end 512 of the drain tube 51 and connected with the drain tube 51, and the opening of the spray element 53 is disposed towards the bottom of the inner tank 12. Moreover, the spray element 53 can be located between the spray nozzles 23 in the first feeding module 20 and the spray nozzles 33 in the second feeding module 30.

The automatic control module 60 comprises a programmable logic controller (PLC), and the automatic control module 60 is electrically connected to the fluoride ion concentration sensor 17, the turbidity sensor 18, the optical fiber sensor 19, the first pump 24, the second pump 34, and the discharging pump 42. Specifically, the automatic control module 60 is electrically connected to the fluoride ion concentration sensor 17 to receive an in-situ data of the fluoride ion concentration detected by the fluoride ion concentration sensor 17. The first pump 24 and/or the second pump 34 are controlled based on the in-situ data of the fluoride ion concentration detected by the automatic control module 60, so as to respectively control the feeding flow rate from the first feeding tank 21 flowing through the first feeding tube 22 and/or the feeding flow rate from the second feeding tank 31 flowing through the second feeding tube 32 of the reaction solution. In addition, the automatic control module 60 is electrically connected to the turbidity sensor 18 to receive an in-situ turbidity data detected by the turbidity sensor 18, and it controls the supply pump 52 of the carrier circulation module 50 based on the detected in-situ turbidity data to control the upflow velocity of the carrier-containing solution flowing through the drain tube 51 to the reaction area A1 extracted from the confluence area A2; in addition, the automatic control module 60 is electrically connected to the optical fiber sensor 19 to receive whether the optical fiber sensor 19 detects fluorine-containing crystals. That is, whether the fluorine-containing crystals precipitated to the crystal collection area A3 are accumulated to a certain volume and reach a predetermined height, and the discharging pump 42 of the crystal treatment module 40 is controlled by the automatic control module 60 based on the sensing result, so as to control whether the fluorine-containing crystals in the crystal collection area A3 are discharged from the crystal outlet 14 to the centrifuge device 43 for subsequent treatment or purification steps, and the fluorine-containing crystalline product is thereby collected.

an Automatic Method for Producing the Fluorine-Containing Crystalline Product from Hydrofluoric Acid Solution

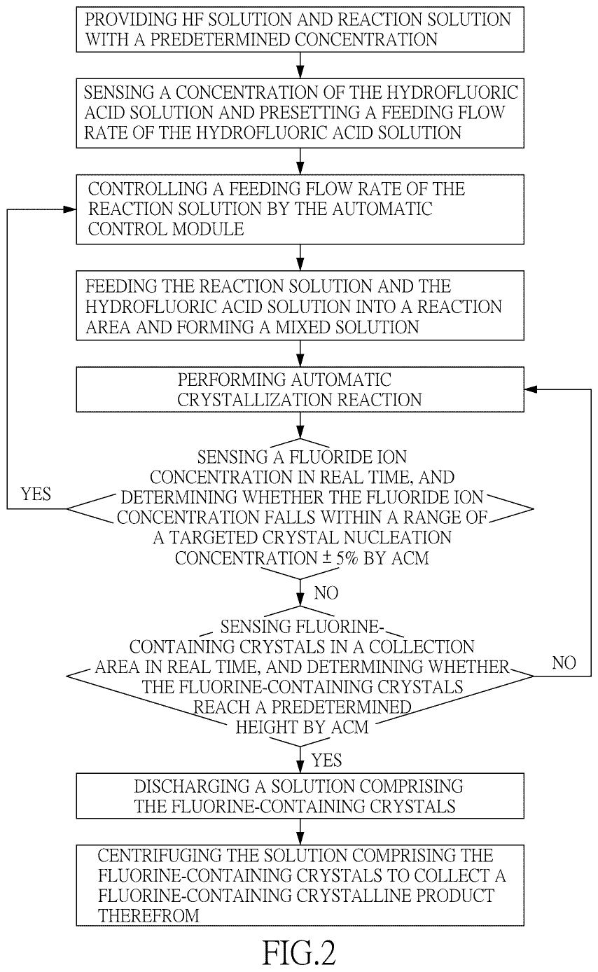

As shown in FIG. 2, the automatic method for producing the fluorine-containing crystalline product in the present invention comprises:

(1) providing a hydrofluoric acid solution (or a hydrofluoric acid solution to be reacted) and a reaction solution with a predetermined concentration, and the reaction solution may be an aluminate solution such as a sodium aluminate solution, an aluminum sulfate solution, and a polyaluminum chloride solution or a silicate solution such as a sodium silicate solution;

(2) sensing a fluoride ion concentration of the hydrofluoric acid solution and presetting a feeding flow rate of the hydrofluoric acid solution;

(3) outputting a predetermined flow rate of the reaction solution by an automatic control module (ACM) based on the fluoride ion concentration and the feeding flow rate of the hydrofluoric acid solution and the predetermined concentration of the reaction solution;

(4) feeding the reaction solution into a reaction area at the predetermined flow rate, and feeding the hydrofluoric acid solution into the reaction area at the feeding flow rate, so as to perform a crystallization reaction and form a mixed solution in the reaction area;

(5) sensing a fluoride ion concentration of the mixed solution in the reaction area in real time while feeding the reaction solution and the hydrofluoric acid solution, receiving an in-situ parameter of the fluoride ion concentration of the mixed solution in the reaction area by the automatic control module, and controlling a feeding flow rate of the reaction solution in real time by the automatic control module under conditions that:
when the in-situ parameter of the fluoride ion concentration received by the automatic control module falls within a range of a targeted crystal nucleation concentration±5%, the feeding flow rate of the reaction solution is controlled to be equal to the predetermined flow rate of the reaction solution;
when the in-situ parameter of the fluoride ion concentration is higher than 5% above the targeted crystal nucleation concentration, the feeding flow rate of the reaction solution is controlled to be greater than the predetermined flow rate of the reaction solution; and
when the in-situ parameter of the fluoride ion concentration is lower than 5% below the targeted crystal nucleation concentration, the feeding flow rate of the reaction solution is controlled to be less than the predetermined flow rate of the reaction solution;

(6) sensing multiple fluorine-containing crystals produced by the crystallization reaction and precipitated to a crystal collection area in real time, and controlling whether to discharge a solution comprising the fluorine-containing crystals by the automatic control module based on whether the fluorine-containing crystals reach a predetermined height; and

(7) centrifuging the solution with fluorine-containing crystals to collect a fluorine-containing crystalline product (such as a sodium fluoroaluminate crystalline product or a sodium fluorosilicate crystalline product) from the solution.

In one of the embodiments, when an aluminate solution is chosen as the reaction solution for preparing the sodium fluoroaluminate crystalline product, the concentration of the hydrofluoric acid solution (or the hydrofluoric acid solution to be reacted) may be 10 g/L to 400 g/L, but is not limited thereto; the reaction solution may be prepared as an aluminate solution with a fluoride ion concentration of 25 g/L to 260 g/L, but is not limited thereto. In another embodiment, when a silicate solution is chosen as the reaction solution for preparing the sodium fluorosilicate crystalline product, the concentration of the hydrofluoric acid solution (or the hydrofluoric acid solution to be reacted) May be 10 g/L to 400 g/L, but is not limited thereto; the reaction solution may be prepared as a silicate solution with a silicon ion concentration of 30 g/L to 320 g/L, but is not limited thereto. Optionally, the concentration of the hydrofluoric acid solution may be input to the automatic control module after manual measurement, or the concentration of the hydrofluoric acid solution may be sent to the automatic control module after detected by the concentration sensor. The predetermined flow rate of the reaction solution is then set and controlled by the automatic control module based on the fluoride ion concentration parameter.

In one of the embodiments, when the aluminate solution is a sodium aluminate solution, the hydrofluoric acid solution and the aluminate solution fed into the reaction area may react as follows: 12HF+3NaAlO₂→Na₃AlF₆+2AlF₃+6H₂O. In another embodiment, when the aluminate solution is an aluminum sulfate solution containing sodium chloride, the hydrofluoric acid solution and the aluminate solution fed into the reaction area may react as follows: 12HF+Al₂(SO₄)₃+6NaCl→2Na₃AlF₆+3H₂SO₄+6HCl. In another embodiment, when the aluminate solution is an polyaluminum chloride solution containing sodium chloride, the hydrofluoric acid solution and the aluminate solution fed into the reaction area may react as follows: 12HF+Al₂(OH)Cl₅+6NaCl→2Na₃AlF₆+11HCl+H₂O. The predetermined flow rate of the aluminate solution may be outputted by the automatic control module according to the aforementioned reaction formula and the calculation that a ratio of the aluminum ion concentration ([Al³⁺]) of the aluminate solution to the fluoride ion concentration ([F⁻]) of the hydrofluoric acid solution is 1:6 to 1.05:6, which is converted from the theoretical basis of the aluminum-to-fluorine ratio of forming sodium fluoroaluminate (Na₃AlF₆). Or, the hydrofluoric acid solution and the silicate solution fed into the reaction area may react as follows: 6HF+Na₂SiO₃→Na₂SiF₆+3H₂O. The predetermined flow rate of the silicate solution may be outputted by the automatic control module according to the aforementioned reaction formula and the calculation that a ratio of the silicon ion concentration ([Si⁴⁺]) of the silicate solution to the fluoride ion concentration ([F⁻]) of the hydrofluoric acid solution is 1:6 to 1.05:6, which is converted from the theoretical basis of the aluminum-to-fluorine ratio of forming sodium fluorosilicate (Na₂SiF₆).

In the process of automatically inducing crystallization reaction, controlling the feeding flow rate of the reaction solution by the automatic control module in real time based on the in-situ parameter of the fluoride ion concentration, in order to make the in-situ parameter of the fluoride ion concentration detected in the reaction area controlled within the corresponding targeted crystal nucleation concentration in the meta-stable area, wherein the corresponding targeted crystal nucleation concentration in the meta-stable area may be 1500 ppm to 12000 ppm.

Preferably, in the process of automatically inducing crystallization reaction, when the in-situ parameter of the fluoride ion concentration of the mixed solution in the reaction area received by the automatic control module is 5% to 10% above the targeted crystal nucleation concentration, the feeding flow rate of the reaction solution is controlled by the automatic control module to be 1.5% to 2.5% above the predetermined flow rate of the reaction solution; when the in-situ parameter of the fluoride ion concentration of the mixed solution in the reaction area received by the automatic control module is 5% to 10% below the targeted crystal nucleation concentration, the feeding flow rate of the reaction solution is controlled by the automatic control module to be 1.5% to 2.5% below the predetermined flow rate of the reaction solution; when the in-situ parameter of the fluoride ion concentration of the mixed solution in the reaction area received by the automatic control module is 10% to 20% above the targeted crystal nucleation concentration, the feeding flow rate of the reaction solution is controlled by the automatic control module to be 3.5% to 4.5% above the predetermined flow rate of the reaction solution; when the in-situ parameter of the fluoride ion concentration of the mixed solution in the reaction area received by the automatic control module is 10% to 20% below the targeted crystal nucleation concentration, the feeding flow rate of the reaction solution is controlled by the automatic control module to be 3.5% to 4.5% below the predetermined flow rate of the reaction solution; when the in-situ parameter of the fluoride ion concentration of the mixed solution in the reaction area received by the automatic control module is 20% to 30% above the targeted crystal nucleation concentration, the feeding flow rate of the reaction solution is controlled by the automatic control module to be 7.5% to 8.5% above the predetermined flow rate of the reaction solution; when the in-situ parameter of the fluoride ion concentration of the mixed solution in the reaction area received by the automatic control module is 20% to 30% below the targeted crystal nucleation concentration, the feeding flow rate of the reaction solution is controlled by the automatic control module to be 7.5% to 8.5% below the predetermined flow rate of the reaction solution; when the in-situ parameter of the fluoride ion concentration of the mixed solution in the reaction area received by the automatic control module is higher than 30% above the targeted crystal nucleation concentration, the feeding flow rate of the reaction solution is controlled by the automatic control module to be 14.5% to 15.5% above the predetermined flow rate of the reaction solution; when the in-situ parameter of the fluoride ion concentration of the mixed solution in the reaction area received by the automatic control module is lower than 30% below the targeted crystal nucleation concentration, the feeding flow rate of the reaction solution is controlled by the automatic control module to be at least 14.5% to 15.5% below the predetermined flow rate of the reaction solution; when the in-situ parameter of the fluoride ion concentration of the mixed solution in the reaction area received by the automatic control module is lower than the limit concentration, the feeding flow rate of the reaction solution is controlled by the automatic control module to be 0, and the limit concentration may be 500 ppm to 1000 ppm.

Optionally, before starting to feed the hydrofluoric acid solution and the reaction solution, feed water or a recycled carrier-containing solution (the carrier-containing solution may be recycled from the production process of the previous batch) into the reaction area in advance, and then continuously feed the hydrofluoric acid solution at the feeding flow rate and the reaction solution at the predetermined flow rate into the reaction area. In addition, in the process of automatically inducing crystallization reaction, it is also optional to stir the mixed solution in the reaction area at the stirring speed of 40 rpm to 120 rpm.

Preferably, continuously feed the reaction solution and/or the hydrofluoric acid solution into the reaction area by spraying to increase reaction contact area. Described spray shapes of spraying may be sector, hollow cone, solid cone, spiral, or cylindrical, but are not limited thereto. In one of the embodiments, the hydrofluoric acid solution may be fed into the upper part of the reaction area, and the reaction solution may be fed into the lower part of the reaction area. In another embodiment, the hydrofluoric acid solution may be fed into the lower part of the reaction area, and the reaction solution may be fed into the upper part of the reaction area. Preferably, one of the reaction solution and the hydrofluoric acid solution is sprayed into the shape of a sector or a solid cone and fed into the upper part of the reaction area, and the other of the reaction solution and the hydrofluoric acid solution is sprayed into the shape of a hollow cone or a spiral and fed into the lower part of the reaction area.

Optionally, besides detecting the fluoride ion concentration of the mixed solution in the reaction area in real time, detect a turbidity of a confluence area in real time when feeding the reaction solution and the hydrofluoric acid solution, receive an in-situ turbidity parameter from the automatic control module, and control the flow rate of the carrier-containing solution in the confluence area flowing to the reaction area in real time based on the in-situ turbidity parameter, in order to control the upflow velocity of the carrier-containing solution in the confluence area, wherein the confluence area is located between and interconnected with the reaction area and the crystal collection area. When the in-situ turbidity parameter received by the automatic control module is higher than 100 NTU, the upflow velocity of the carrier-containing solution in the confluence area controlled by the automatic control module is 0.4 cm/s to 0.6 cm/s. When the in-situ turbidity parameter received by the automatic control module is lower than 100 NTU, the upflow velocity of the carrier-containing solution in the confluence area controlled by the automatic control module is 2.2 cm/s to 2.6 cm/s. When the upflow velocity in the confluence area is increased by the automatic control module based on the in-situ turbidity parameter, the upflow velocity in the confluence area is increased at an increasing rate of 0.25 cm/s to 0.75 cm/s per minute. Optionally, the carrier-containing solution may also be guided back to the reaction area by spraying to increase reaction contact area. Described spray shapes of spraying may be sector, hollow cone, solid cone, spiral, or cylindrical, preferably sector or solid cone, but are not limited thereto.

Several examples are further listed below to illustrate how to perform the automatic method with the automatic system for producing the fluorine-containing crystalline product from the hydrofluoric acid solution. A person skilled in the art can easily realize the advantages and effects of the present invention from the following examples and comparative examples. The descriptions proposed herein are just preferable embodiments for the purpose of illustrations only, not intended to limit the scope of the present application. Various modifications and variations could be made in order to practice or apply the present invention without departing from the spirit and scope of the present application.

### Example 1: Automatically Producing Sodium Fluoroaluminate Crystalline Product from the Hydrofluoric Acid Solution

In this example, a hydrofluoric acid waste solution recovered from manufacturer A, which was used as a material, was continuously fed into the upper part of the inner tank 12 of the crystallization device 10, and the sodium aluminate solution (i.e., the aluminate solution used as the reaction solution) was continuously fed into the lower part of the inner tank 12 of the crystallization device 10, so as to obtain the sodium fluoroaluminate crystalline product with a simple process from the automatic method described below. The specific implementation is illustrated below corresponding to FIG. 2 to FIG. 4.

First, the hydrofluoric acid waste solution stored in the second feeding tank 31 of the second feeding module 30 was provided, and the concentration detected with the concentration sensor 171 was 112.1 g/L. The concentration parameter was sent to the automatic control module 60. In addition, the feeding flow rate of the hydrofluoric acid waste solution into the reaction area A1 was preset to be 40 liters per minute (lpm).

On the other hand, a sodium aluminate solution was prepared and stored in the first feeding tank 21 of the first feeding module 20. The predetermined concentration of the sodium aluminate solution was: the aluminum ion concentration was 82.0 g/L, and the sodium ion concentration was 210.0 g/L. The predetermined concentration parameters were input into the automatic control module 60. A predetermined parameter of the flow rate of the sodium aluminate solution was calculated and output by the automatic control module 60 according to the reaction formula and theoretical basis, so the preparation work before inducing the crystallization reaction was finished. Herein, the concentration parameter of the hydrofluoric acid waste solution detected with the concentration sensor 171 was received by the automatic control module 60, the predetermined flow rate parameter of the sodium aluminate solution was calculated and output to the second pump 34 via 112.1*40÷19÷6×27÷82×1.04=13.5 according to the concentration parameter and the feeding flow rate of the hydrofluoric acid waste solution and the predetermined concentration of the sodium aluminate solution, so that the sodium aluminate solution was controlled to be continuously fed into the reaction area A1 initially at a predetermined flow rate of 13.5 lpm.

Before the hydrofluoric acid waste solution and the sodium aluminate solution were continuously fed, clear water may be fed into the inner tank 12 of the crystallization device 10 to make the surface level of the clear water about 5 cm higher than the first feeding tube 22. Afterwards, the first pump 24 was controlled by the automatic control module 60 based on the aforementioned parameter of the output predetermined flow rate, making the sodium aluminate solution in the first feeding tank 21 flow through the first feeding tube 22 and the spray nozzles 23 in advance, and the sodium aluminate solution was continuously fed into the lower part of the reaction area A1 by spraying at the predetermined flow rate of 13.5 lpm for 30 seconds. Hereafter, the second pump 34 was controlled by the automatic control module 60, making the hydrofluoric acid waste solution in the second feeding tank 31 flow through the second feeding tube 32 and the spray nozzles 33, and the hydrofluoric acid waste solution was continuously fed into the upper part of the reaction area A1 at the feeding flow rate of 40 lpm by spraying, in order to form a mixed solution comprising the sodium aluminate solution and the hydrofluoric acid waste solution. The mixed solution was continuously stirred in the reaction area A1 evenly with the stirring unit 122 in the feeding process, and the stirring speed remains at 120 rpm in the entire process.

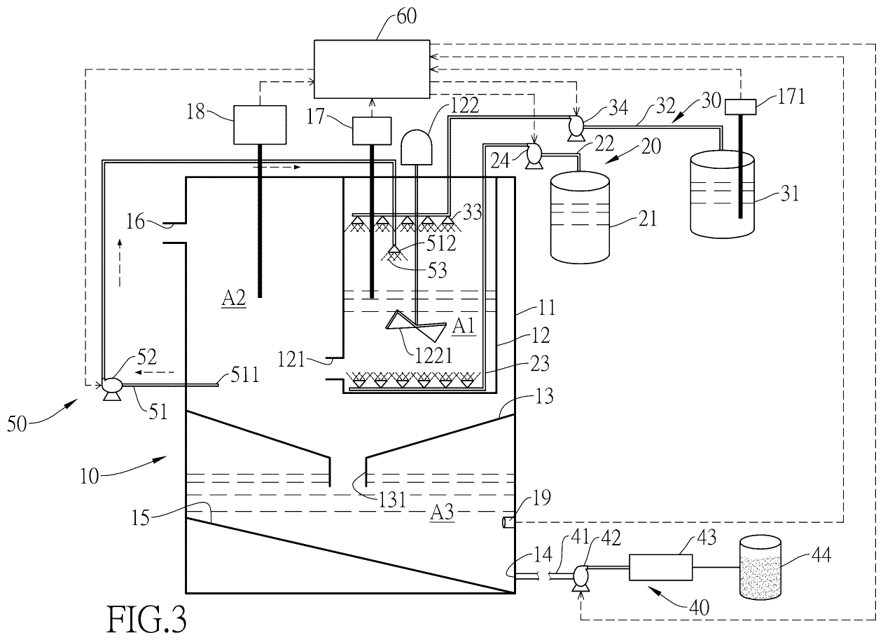

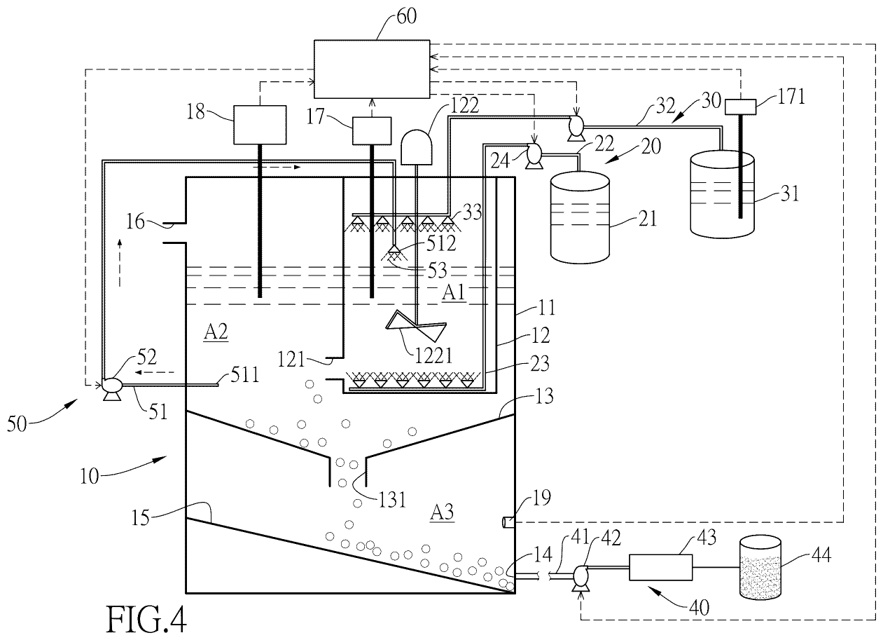

After the sodium aluminate solution and the hydrofluoric acid waste solution were continuously fed into the inner tank 12 of the crystallization device 10 for a while, as shown in FIG. 3, after the hydrofluoric acid solution and the sodium aluminate solution were fed, the mixed solution in the reaction area A1 may flow through the flowing outlet 121 into the confluence area A2 and downward through the settling outlet 131, merging into the crystal collection area A3 and causing the liquid level to rise slowly from the bottom of the outer tank 11 and to gradually approach the level of the suction end 511 of the drain tube 51. After the hydrofluoric acid solution and the sodium aluminate solution were continuously fed, the liquid level slowly rose to be higher than the level of the suction end 511 of the drain tube 51, as shown in FIG. 4. At this time, the mixed solution may flow within the reaction area A1, the confluence area A2, and the crystal collection area A3.

After the continuous feeding of the sodium aluminate solution and the hydrofluoric acid waste solution into the reaction area A1 of the inner tank 12 of the crystallization device 10, the fluoride ion concentration sensor 17 started to detect the in-situ parameter of the fluoride ion concentration of the mixed solution in the reaction area A1, and the in-situ parameter of the fluoride ion concentration was sent to the automatic control module 60 in real time. The in-situ parameter of the fluoride ion concentration was received from the fluoride ion concentration sensor 17 by the automatic control module 60 and the second pump 34 was controlled based on the detected in-situ parameter to adjust the feeding flow rate of the sodium aluminate solution in real time, so that the in-situ parameter of the fluoride ion concentration of the mixed solution in the reaction area A1 was controlled to be the targeted crystal nucleation concentration (referred to as targeted concentration in Table 1 below) or less corresponding to the meta-stable area as much as possible, thereby facilitating the induction of the crystallization reaction. In this example, the targeted crystal nucleation concentration corresponding to the meta-stable area during the induced crystallization reaction was 2000 ppm. The detected in-situ parameter of the fluoride ion concentration was received by the automatic control module 60 in real time, and the feeding flow rate of the sodium aluminate solution was controlled in real time according to the relationship between the in-situ parameter of the fluoride ion concentration and the feeding flow rate of the sodium aluminate solution shown in Table 1 below, so that the in-situ fluoride ion concentration of the mixed solution was controlled to be 2000 ppm or less during the automatic production process as much as possible.

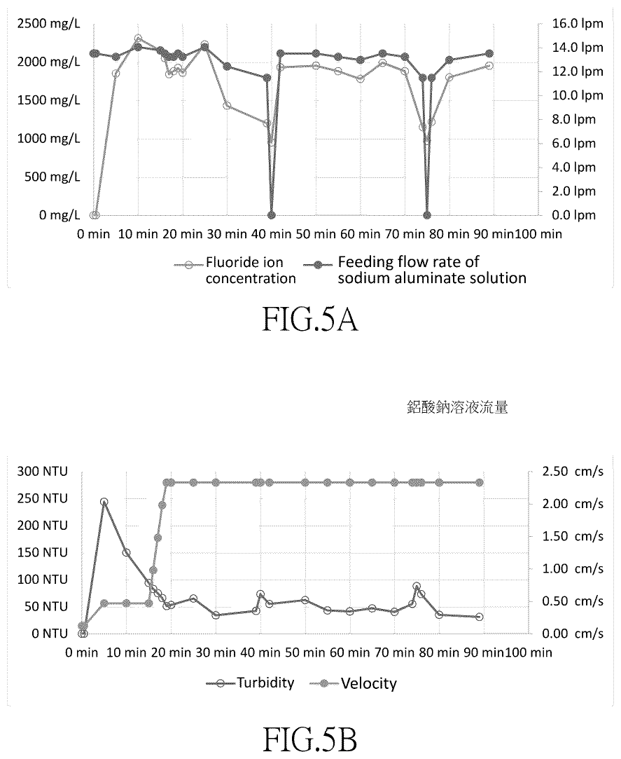

Specifically, in this example, the result of controlling the feeding flow rate of the sodium aluminate solution according to the actually detected in-situ parameter of the fluoride ion concentration in the induced crystallization reaction is shown in FIG. 5A. At the 5^{th} minute of continuous feeding of the sodium aluminate solution (the 4.5^{th} minute of continuous feeding of the hydrofluoric acid waste solution), the in-situ parameter of the fluoride ion concentration was detected to be 1850 ppm (equivalent to a 5% to 10% reduction in the targeted concentration), so the feeding flow rate of the sodium aluminate solution was controlled to be approximately 13.2 lpm by the automatic control module 60; at the 10^{th} minute of continuous feeding of the sodium aluminate solution, the in-situ parameter of the fluoride ion concentration was detected to be 2310 ppm (equivalent to a 10% to 20% increase in the targeted concentration), so the feeding flow rate of the sodium aluminate solution was controlled to be approximately 14.0 lpm by the automatic control module 60; at the 40^{th} minute of continuous feeding of the sodium aluminate solution, the in-situ parameter of the fluoride ion concentration was lower than 1000 ppm, so the feeding of the sodium aluminate solution was automatically stopped by the automatic control module 60; the detected in-situ parameters of the fluoride ion concentration and the results of controlling the feeding flow rate of the sodium aluminate solution at the remaining time are shown in FIG. 5A.

TABLE 1
The feeding flow rate of the sodium aluminate solution controlled
by the automatic control module according to the in-situ
parameter of the fluoride ion concentration of the mixed
solution in the reaction area in example 1

| In-situ parameter of | | Feeding flow rate of | |
|---|---|---|---|
| the fluoride ion | | the sodium aluminate | |
| concentration ([F⁻], ppm) | | solution (lpm) | |
| Higher than 30% | [F⁻] > 2600 | 15% above the | 13.5 + 2.025 |
| above the | | predetermined | |
| targeted | | flow rate | |
| concentration | | | |
| 20%~30% above | 2400 < [F⁻] ≤ 2600 | 8% above the | 13.5 + 1.08 |
| the targeted | | predetermined | |
| concentration | | flow rate | |
| 10%~20% above | 2200 < [F⁻] ≤ 2400 | 4% above the | 13.5 + 0.54 |
| the targeted | | predetermined | |
| concentration | | flow rate | |
| 5%~10% above | 2100 < [F⁻] ≤ 2200 | 2% above the | 13.5 + 0.27 |
| the targeted | | predetermined | |
| concentration | | flow rate | |
| Within 5% above | 2000 < [F⁻] ≤ 2100 | Predetermined | 13.5 |
| the targeted | | flow rate | |
| concentration | | | |
| Targeted | 2000 | Predetermined | 13.5 |
| concentration | | flow rate | |
| Within 5% below | 1900 ≤ [F⁻] < 2000 | Predetermined | 13.5 |
| the targeted | | flow rate | |
| concentration | | | |
| 5%~10% below | 1800 ≤ [F⁻] < 1900 | 2% below the | 13.5 − 0.27 |
| the targeted | | predetermined | |
| concentration | | flow rate | |
| 10%~20% below | 1600 ≤ [F⁻] < 1800 | 4% below the | 13.5 − 0.54 |
| the targeted | | predetermined | |
| concentration | | flow rate | |
| 20%~30% below | 1400 ≤ [F⁻] < 1600 | 8% below the | 13.5 − 1.08 |
| the targeted | | predetermined | |
| concentration | | flow rate | |
| Lower than 30% | [F⁻] < 1400 | 15% below the | 13.5 − 2.025 |
| below the | | predetermined | |
| targeted | | flow rate | |
| concentration | | | |
| Lower than | [F⁻] < 1000 | Stop feeding | 0 |
| the limit | | | |
| concentration | | | |

After the 5^{th} minute of feeding the sodium aluminate solution, the liquid level reached to be higher than the height of the suction end 511 of the drain tube 51 and the sensing end of the turbidity sensor 18. At this time, the in-situ fluoride ion concentration of the mixed solution in the reaction area A1 was not only detected in real time with the fluoride ion concentration sensor 17, but the turbidity of the carrier-containing solution in the confluence area A2 was also detected in real time when the sodium aluminate solution and the hydrofluoric acid solution were continuously fed and the crystallization reaction was induced. The in-situ turbidity parameter detected with the turbidity sensor 18 was received and the supply pump 52 of the carrier circulation module 50 was controlled according to the in-situ turbidity parameter by the automatic control module 60, so that the velocity of the carrier-containing solution in the confluence area A2 absorbed from the suction end 511 and guided back to the reaction area A1 was controlled in real time, in order to facilitate the induction of the crystallization reaction.

Specifically, during the first 5 minutes after the sodium aluminate solution started to be fed, the liquid level hadn't reached the sensing end of the turbidity sensor meter 18 yet, and the automatic control module 60 hadn't received the in-situ turbidity parameter and controlled the supply pump 52 yet. At this time, the upflow velocity of the solution containing the self-assembled carrier in the confluence area A2 was 0.151 cm/s. At the 5^{th} minute after the sodium aluminate solution started to be fed, the actual detected in-situ turbidity parameter received by the automatic control module 60 was higher than 100 NTU, and the supply pump 52 was controlled by the automatic control module 60 to guide the carrier-containing solution in the confluence area A2 back to the reaction area A1 at a velocity of 9.96 cubic meters per hour (CMH), thereby making the upflow velocity of the solution containing the self-assembled carrier in the confluence area A2 0.47 cm/s, and the suspended seed crystals were lifted at a low flow rate and guided back to the reaction area to continue growing. When the in-situ turbidity parameter received by the automatic control module 60 was lower than 100 NTU, meaning that the particle size had grown to a certain extent, so that the upflow velocity of the solution containing the self-assembled carrier in the confluence area A2 was increased at an increasing rate of 0.5 cm/s per minute by the automatic control module 60, and the upflow velocity was controlled to rise to 2.33 cm/s, thereby making the crystals grown to the targeted particle size gradually precipitate to the crystal collection area A3, so as to facilitate the subsequent deposition of the sodium fluoroaluminate crystals in the crystal collection area A3 into a quicksand-like accumulation. The result of controlling the upflow velocity of the solution containing the self-organizing carrier in the confluence area A2 by the automatic control module 60 according to the received in-situ turbidity parameter is shown in FIG. 5B. Illustrated in this example, when the guided flow rate of the supply pump 52 controlled by the automatic control module 60 was 9.96 CMH, the upflow velocity in the confluence area A2 was 0.47 cm/s; when the guided flow rate of the supply pump 52 controlled by the automatic control module 60 was 10.62 CMH, the upflow velocity in the confluence area A2 was 0.50 cm/s; when the guided flow rate of the supply pump 52 controlled by the automatic control module 60 was 21.18 CMH, the upflow velocity in the confluence area A2 was 1.00 cm/s; when the guided flow rate of the supply pump 52 controlled by the automatic control module 60 was 31.86 CMH, the upflow velocity in the confluence area A2 was 1.50 cm/s; when the guided flow rate of the supply pump 52 controlled by the automatic control module 60 was 42.48 CMH, the upflow velocity in the confluence area A2 was 2.00 cm/s; when the guided flow rate of the supply pump 52 controlled by the automatic control module 60 was 49.49 CMH, the upflow velocity in the confluence area A2 was 2.33 cm/s. Besides, with the optical fiber sensor 19 installed below the settling funnel 13 and a certain distance higher than the crystal outlet 14, the sodium fluoroaluminate crystals precipitated on the guiding board 15 of the crystal collection area A3 after reaction were detected in real time, and whether to discharge the solution containing the sodium fluoroaluminate crystals was controlled by the automatic control module 60 according to whether the sodium fluoroaluminate crystals reach a predetermined height.

It can be known herein that FIG. 5A and FIG. 5B only show the data of adjusting the feeding flow rate of the sodium aluminate solution according to the in-situ parameter of the fluoride ion concentration detected every 5 minutes and adjusting the upflow velocity in the confluence area according to the in-situ turbidity parameter detected every 5 minutes. The frequency of the detecting and the controlling was not particularly limited, and a person skilled in the art can adjust the frequency of detecting the in-situ fluoride ion concentration and controlling the feeding flow rate as needed.

The total reaction time of example 1 was 90 minutes. During the reaction, the feeding flow rate of the hydrofluoric acid waste solution was fixed, the feeding flow rate of the sodium aluminate solution was controlled by the automatic control module 60 in real time according to the detected in-situ parameter of the fluoride ion concentration, and the upflow velocity of the solution containing the self-assembled carrier in the confluence area was controlled according to the detected in-situ turbidity parameter. In this example, at the 22^{nd} minute during feeding, the optical fiber sensor 19 detected for the first time that the sodium fluoroaluminate crystals had accumulated to a predetermined height on the guiding board 15. At 1 atm, the discharging pump 42 of the crystal treatment module 40 was controlled to open by the automatic control module 60, so that the solution containing the sodium fluoroaluminate crystals (in-situ fluoride ion concentration of 1450 ppm, in-situ turbidity of 36 NTU) flew from the crystal outlet 14 through the discharging tube 41 and was discharged to the centrifuge device 43. After the solution containing the sodium fluoroaluminate crystals was centrifuged and dehydrated by the centrifuge device 43, about 750 kilograms (kg) of a sodium fluoroaluminate crystalline product (cryolite) could be obtained. The sodium fluoroaluminate crystalline product could be stored in the product collection tank 44. After the 750 kg of the sodium fluoroaluminate crystalline product was dried, 695 kg of a dry product with a moisture content of about 7.3% could be obtained.

Analyzed by filtering particle size, the dry product with a particle size larger than 200 mesh accounted for about 82% to 85%. The contents of aluminum (CNS 10116), fluorine (CNS 10113) and sodium (CNS 10115) in natural and artificial cryolites were further analyzed using National Standards of the Republic of China (CNS). After the sodium fluoroaluminate crystalline products were randomly sampled for three times for the composition analysis using the CNS method, the proportions of fluorine, sodium, and aluminum were respectively found to be 53.65 weight % (wt %), 30.79 wt %, and 12.80 wt % after averaged, and the average sodium-to-aluminum molecular ratio (the molar ratio of sodium element to aluminum element) was 2.82. The specific testing results are shown in Table 2. The testing results confirm that example 1 can indeed produce a sand-like, high-quality sodium fluoroaluminate crystalline product with a high molecular ratio. Besides the CNS analysis method described above, those skilled in the art may also use other standard analysis methods (such as GB-4291-2007) to analyze the content of each component in the sodium fluoroaluminate crystalline products.

TABLE 2
The results of analyzing the fluorine, sodium,
and aluminum components of the sodium fluoroaluminate
crystalline products in example 1

| | | | | Sodium-to-aluminum |
|---|---|---|---|---|
| | Fluorine | Sodium | Aluminum | molecular ratio |
| | (wt %) | (wt %) | (wt %) | (mol/mol) |
| 1 | 53.66 | 30.75 | 12.96 | 2.79 |
| 2 | 53.72 | 30.70 | 12.74 | 2.83 |
| 3 | 53.56 | 30.92 | 12.71 | 2.86 |
| Average | 53.65 | 30.79 | 12.80 | 2.82 |

The above testing results confirm that the automatic method for producing sodium fluoroaluminate from an automatic system in example 1 can indeed recycle the high-concentration hydrofluoric acid waste solution into cryolites with high economic value. Specifically, in example 1, the high-concentration hydrofluoric acid waste solution (112.1 g/L) was processed into a solution with a fluoride ion concentration of about 1450 ppm via the automatic method, and the removal rate was as high as 98.7%.

### Example 2: Automatically Producing Sodium Fluoroaluminate Crystalline Product from the Hydrofluoric Acid Solution

In this example, the hydrofluoric acid waste solution recovered from manufacturer A was also used as a material, and the automatic system for producing sodium fluoroaluminate substantially same as the system in FIG. 1, FIG. 3, and FIG. 4 could be used to produce sodium fluoroaluminate crystalline products. The difference of example 2 from example 1 is that the hydrofluoric acid waste solution was continuously fed into the lower part of the inner tank 12 of the crystallization device 10, and an aluminum sulfate solution containing sodium chloride (i.e., an aluminate solution used as a reaction solution) was continuously fed into the upper part of the inner tank 12 of the crystallization device 10. Furthermore, the concentration sensor (not shown in FIG) of the automatic system was not installed at the position shown in the concentration sensor 171 of FIG. 3 and FIG. 4, but was installed in the first feeding tank 21 of FIG. 1.

For ease in understanding of the present invention, the similar part of the automatic method in example 2 and example 1 will not be described in detail. The following mainly describes the different control methods or conditions between example 2 and example 1.

The hydrofluoric acid waste solution in this example was stored in the first feeding tank 21 of the first feeding module 20, and the prepared aluminum sulfate solution containing sodium chloride with a predetermined concentration was stored in the second feeding tank 31 of the second feeding module 30. The concentration and predetermined flow rate of the hydrofluoric acid waste solution were the same as in example 1, and the predetermined concentration of the aluminum sulfate solution containing sodium chloride in example 2 was: the aluminum ion concentration was 82.0 g/L, and the sodium ion concentration was 210.0 g/L.

Before the hydrofluoric acid waste solution and the aluminum sulfate solution containing sodium chloride were continuously fed, clear water may be fed into the inner tank 12 of the crystallization device 10, in order to make the surface level of the clear water about 5 cm higher than the first feeding tube 22. Afterwards, the second pump 34 was controlled by the automatic control module 60 based on the output predetermined flow rate parameter (13.5 lpm) of the aluminum sulfate solution containing sodium chloride (referred to as aluminate solution), making the aluminate solution flow through the second feeding tube 32 and continuously fed into the upper part of the reaction area A1 by spraying for 30 seconds. Hereafter, the first pump 24 was controlled by the automatic control module 60, making the hydrofluoric acid waste solution flow through the first feeding tube 22 at the feeding flow rate of 40 lpm and continuously fed into the lower part of the reaction area A1 by spraying, in order to form a mixed solution comprising the aluminate solution and the hydrofluoric acid waste solution. The mixed solution in the reaction area A1 was continuously stirred evenly with the stirring unit 122 in the feeding process, and the stirring speed remains at 120 rpm.

At the 5^{th} minute of continuous feeding of the aluminate solution (the 4.5^{th} minute of continuous feeding of the hydrofluoric acid waste solution), the automatic control module 60 started to receive the in-situ parameter of the fluoride ion concentration and control the second pump 34 to control the feeding flow rate of the aluminate solution. Meanwhile, the in-situ turbidity parameter was also received and the supply pump 52 was controlled by the automatic control module 60 to adjust the upflow velocity of the solution containing the self-assembled carrier in the confluence area A2.

In this example, the targeted crystal nucleation concentration corresponding to the meta-stable area during the induced crystallization reaction was 1500 ppm. The detected in-situ parameter of the fluoride ion concentration was received in real time by the automatic control module 60, and the feeding flow rate of the aluminate solution was controlled in real time according to the relationship between the in-situ parameter of the fluoride ion concentration and the feeding flow rate of the aluminate solution shown in Table 3 below, so that the in-situ fluoride ion concentration of the mixed solution was controlled to be 1500 ppm or less during the automatic production process as much as possible.

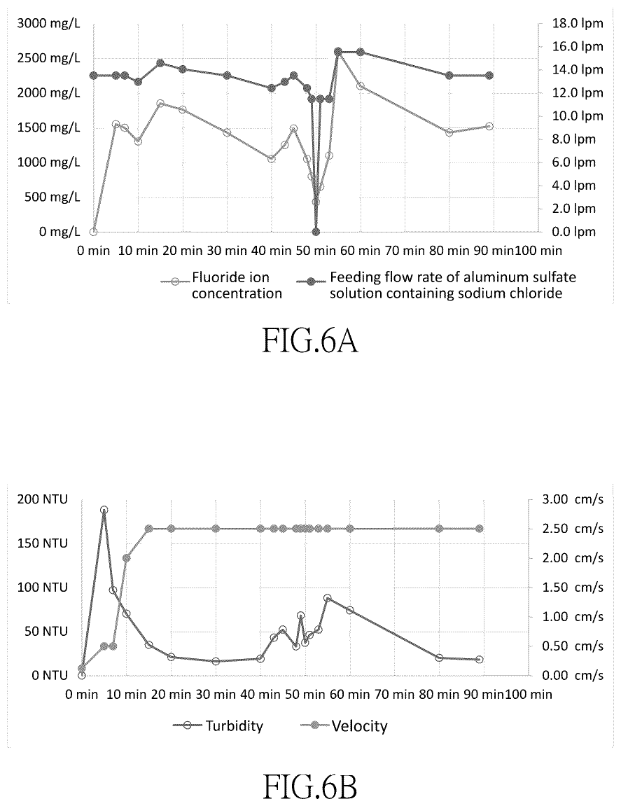

Specifically, in this example, the result of controlling the feeding flow rate of the aluminum sulfate solution containing sodium chloride according to the actually detected in-situ parameter of the fluoride ion concentration in the induced crystallization reaction is shown in FIG. 6A. At the 5^{th} minute of continuous feeding of the aluminate solution (the 4.5^{th} minute of continuous feeding of the hydrofluoric acid waste solution), the in-situ parameter of the fluoride ion concentration was detected to be 1550 ppm (equivalent to an increase within 5% in the targeted concentration), so the feeding flow rate of the aluminate solution was controlled to be equal to the predetermined flow rate (13.5 lpm) by the automatic control module 60; at the 10^{th} minute of continuous feeding of the aluminate solution, the in-situ parameter of the fluoride ion concentration was detected to be 1330 ppm (equivalent to a 10% to 20% increase in the targeted concentration), so the feeding flow rate of the aluminate solution was controlled to be approximately 13.0 lpm by the automatic control module 60; at the 50^{th} minute of continuous feeding of the aluminate solution, the in-situ parameter of the fluoride ion concentration was lower than 500 ppm, so the feeding of the aluminate solution was automatically stopped by the automatic control module 60; the detected in-situ parameters of the fluoride ion concentration and the results of controlling the feeding flow rate of the aluminate solution at the remaining time are shown in FIG. 6A.

TABLE 3
The feeding flow rate of the aluminum sulfate solution containing
sodium chloride controlled by the automatic control module according
to the in-situ parameter of the fluoride ion concentration of
the mixed solution in the reaction area in example 2

| | | Feeding flow rate of | |
|---|---|---|---|
| | | the aluminum sulfate | |
| In-situ parameter | | solution containing | |
| of the fluoride ion | | sodium | |
| concentration ([F⁻], ppm) | | chloride (lpm) | |
| Higher than 30% | [F⁻] > 1950 | 15% above the | 13.5 + 2.025 |
| above the targeted | | predetermined | |
| concentration | | flow rate | |
| 20%~30% above | 1800 < [F⁻] ≤ 1950 | 8% above the | 13.5 + 1.08 |
| the targeted | | predetermined | |
| concentration | | flow rate | |
| 10%~20% above | 1650 < [F⁻] ≤ 1800 | 4% above the | 13.5 + 0.54 |
| the targeted | | predetermined | |
| concentration | | flow rate | |
| 5%~10% above | 1575 < [F⁻] ≤ 1650 | 2% above the | 13.5 + 0.27 |
| the targeted | | predetermined | |
| concentration | | flow rate | |
| Within 5% above | 1500 < [F⁻] ≤ 1575 | Predetermined | 13.5 |
| the targeted | | flow rate | |
| concentration | | | |
| Targeted | 1500 | Predetermined | 13.5 |
| concentration | | flow rate | |
| Within 5% below | 1425 ≤ [F⁻] < 1500 | Predetermined | 13.5 |
| the targeted | | flow rate | |
| concentration | | | |
| 5%~10% below | 1350 ≤ [F⁻] < 1425 | 2% below the | 13.5 − 0.27 |
| the targeted | | predetermined | |
| concentration | | flow rate | |
| 10%~20% below | 1200 ≤ [F⁻] < 1350 | 4% below the | 13.5 − 0.54 |
| the targeted | | predetermined | |
| concentration | | flow rate | |
| 20%~30% below | 1050 ≤ [F⁻] < 1200 | 8% below the | 13.5 − 1.08 |
| the targeted | | predetermined | |
| concentration | | flow rate | |
| Lower than 30% | [F⁻] < 1050 | 15% below the | 13.5 − 2.025 |
| below the | | predetermined | |
| targeted | | flow rate | |
| concentration | | | |
| Lower than | [F⁻] < 500 | Stop feeding | 0 |
| the limit | | | |
| concentration | | | |

During the first 5 minutes after the aluminate solution started to be fed, the upflow velocity of the solution containing the self-assembled carrier in the confluence area A2 was 0.151 cm/s. At the 5^{th} minute after the aluminate solution started to be fed, the actual detected in-situ turbidity parameter received by the automatic control module 60 was 180 NTU. The upflow velocity of the solution containing the self-assembled carrier in the confluence area A2 was controlled by the automatic control module 60 to be 0.50 cm/s based on the in-situ turbidity parameter, the crystal nucleus of the confluence area A2 started to be guided to the reaction area A1 with the small suspended self-assembled carrier. Afterwards, when the in-situ turbidity parameter received by the automatic control module was higher than 100 NTU, the upflow velocity of the solution containing the self-assembled carrier in the confluence area A2 controlled by the automatic control module was 0.50 cm/s. When the in-situ turbidity parameter received by the automatic control module was lower than 100 NTU, the upflow velocity of the solution containing the self-assembled carrier in the confluence area A2 was increased by the automatic control module 60 at an increasing rate of 0.5 cm/s per minute, and the upflow velocity was controlled to rise to 2.50 cm/s, thereby making the crystals grown to the targeted particle size gradually precipitate to the crystal collection area A3, so as to facilitate the deposition of the sodium fluoroaluminate crystals in the crystal collection area A3 into a quicksand-like accumulation. The result of controlling the upflow velocity of the solution containing the self-organizing carrier in the confluence area A2 by the automatic control module 60 according to the received in-situ turbidity parameter is shown in FIG. 6B.

The total reaction time of example 2 was 90 minutes. During the reaction, the feeding flow rate of the hydrofluoric acid waste solution was fixed, the feeding flow rate of the aluminate solution was controlled by the automatic control module 60 in real time according to the detected in-situ parameter of the fluoride ion concentration, and the upflow velocity of the solution containing the self-assembled carrier in the confluence area A2 was controlled according to the detected in-situ turbidity parameter. In this example, at the 18^{th} minute during feeding, the optical fiber sensor 19 detected for the first time that the sodium fluoroaluminate crystals had accumulated to a predetermined height on the guiding board 15. The discharging pump 42 of the crystal treatment module 40 was accordingly controlled to open by the automatic control module 60, so that the solution containing the sodium fluoroaluminate crystals (in-situ fluoride ion concentration of 1320 ppm, in-situ turbidity of 33 NTU) flew from the crystal outlet 14 through the discharging tube 41 and was discharged to the centrifuge device 43. After the solution containing the sodium fluoroaluminate crystals was centrifuged and dehydrated by the centrifuge device 43, about 730 kg of a sodium fluoroaluminate crystalline product (cryolite) could be obtained. The sodium fluoroaluminate crystalline product could be stored in the product collection tank 44. After the 730 kg of the sodium fluoroaluminate crystalline product was dried, 690 kg of a dry product with a moisture content of about 5.5% could be obtained.

Analyzed by filtering particle size, the dry product with a particle size larger than 200 mesh accounted for about 86% to 89%. Tested with the same method as in the previous example 1, the proportions of fluorine, sodium, and aluminum were respectively 53.60 wt %, 33.15 wt %, and 13.14 wt %, and the average sodium-to-aluminum molecular ratio was 2.96. The specific testing results are shown in Table 4. The testing results confirm that example 2 can indeed produce a sand-like, high-quality sodium fluoroaluminate crystalline product with a high molecular ratio.

TABLE 4
The results of analyzing the fluorine, sodium, and aluminum components
of the sodium fluoroaluminate crystalline product in example 2

| | | | | Sodium-to-aluminum |
|---|---|---|---|---|
| | Fluorine | Sodium | Aluminum | molecular ratio |
| | (wt %) | (wt %) | (wt %) | (mol/mol) |
| 1 | 53.61 | 33.15 | 13.14 | 2.96 |
| 2 | 53.48 | 33.08 | 13.22 | 2.94 |
| 3 | 53.72 | 33.22 | 13.05 | 2.99 |
| Average | 53.60 | 33.15 | 13.14 | 2.96 |

The above testing results confirm that the automatic method for producing sodium fluoroaluminate from an automatic system in example 2 can indeed recycle the high-concentration hydrofluoric acid waste solution into cryolites with high economic value. Specifically, in example 2, the high-concentration hydrofluoric acid waste solution (112.1 g/L) was processed into a solution with a fluoride ion concentration of about 1320 ppm via the automatic method, and the removal rate was as high as 98.8%.

### Example 3: Automatically Producing Sodium Fluoroaluminate Crystalline Product from the Hydrofluoric Acid Solution

In this example, the hydrofluoric acid waste solution recovered from manufacturer B was used as a material, and the automatic system for producing sodium fluoroaluminate substantially same as the system in FIG. 1 could be used to produce sodium fluoroaluminate crystalline products. The difference of example 3 from example 1 is that the hydrofluoric acid waste solution was continuously fed into the lower part of the inner tank 12 of the crystallization device 10, and a sodium aluminate solution (i.e., an aluminate solution used as a reaction solution) was continuously fed into the upper part of the inner tank 12 of the crystallization device 10. Furthermore, the concentration sensor (not shown in FIG) of the automatic system was not installed at the position shown in the concentration sensor 171 of FIG. 3 and FIG. 4, but was installed in the first feeding tank 21 of FIG. 1.

For ease in understanding of the present invention, the similar part of the automatic method in example 3 and example 1 will not be described in detail. The following mainly describes the different control methods or conditions between example 3 and example 1.

First, the hydrofluoric acid waste solution was provided and stored in the first feeding tank 21 of the first feeding module 20, the concentration of the hydrofluoric acid waste solution in the first feeding tank 21 detected with the concentration sensor (not shown in FIG) was 235.6 g/L, and the concentration parameter was sent to the automatic control module 60. In addition, the feeding flow rate of the hydrofluoric acid waste solution into the reaction area A1 was preset to be 30 lpm. On the other hand, a sodium aluminate solution was prepared and stored in the second feeding tank 31 of the second feeding module 30. The predetermined concentration of the sodium aluminate solution was: the aluminum ion concentration was 82.0 g/L, and the sodium ion concentration was 210.0 g/L. The predetermined concentration parameters were input into the automatic control module 60. The concentration parameter of the hydrofluoric acid waste solution detected with the concentration sensor was received by the automatic control module 60, the predetermined flow rate parameter of the sodium aluminate solution was calculated and output to the second pump 34 via 235.6*30÷19÷6×27=82× 1.05=21.4 according to the concentration parameter and the feeding flow rate of the hydrofluoric acid waste solution and the predetermined concentration of the sodium aluminate solution, so that the sodium aluminate solution was controlled to be continuously fed into the reaction area A1 initially at a predetermined flow rate of 21.4 lpm.

Before the hydrofluoric acid waste solution and the sodium aluminate solution were continuously fed, clear water may be fed into the inner tank 12 of the crystallization device 10 to make the surface level of the clear water about 5 cm higher than the first feeding tube 22. Afterwards, the second pump 34 was controlled by the automatic control module 60 based on the output predetermined flow rate parameter (21.4 lpm) of the sodium aluminate solution, making the sodium aluminate solution flow through the second feeding tube 32 and continuously fed into the upper part of the reaction area A1 by spraying for 30 seconds. Hereafter, the first pump 24 was controlled by the automatic control module 60, making the hydrofluoric acid waste solution flow through the first feeding tube 22 at the feeding flow rate of 30 lpm and continuously fed into the lower part of the reaction area A1 by spraying, in order to form a mixed solution comprising the sodium aluminate solution and the hydrofluoric acid waste solution. The mixed solution in the reaction area A1 was continuously stirred evenly with the stirring unit 122 in the feeding process, and the stirring speed remains at 120 rpm.

At the 5^{th} minute of continuous feeding of the sodium aluminate solution (the 4.5^{th} minute of continuous feeding of the hydrofluoric acid waste solution), the automatic control module 60 started to receive the in-situ parameter of the fluoride ion concentration and control the second pump 34, in order to control the feeding flow rate of the sodium aluminate solution. Meanwhile, the in-situ turbidity parameter was also received and the supply pump 52 was controlled by the automatic control module 60 to adjust the upflow velocity of the solution containing the self-assembled carrier in the confluence area A2.

In this example, the targeted crystal nucleation concentration corresponding to the meta-stable area during the induced crystallization reaction was 1200 ppm. The detected in-situ parameter of the fluoride ion concentration was received by the automatic control module 60 in real time, and the feeding flow rate of the sodium aluminate solution was controlled in real time according to the relationship between the in-situ parameter of the fluoride ion concentration and the feeding flow rate of the sodium aluminate solution shown in Table 5 below, so that the in-situ fluoride ion concentration of the mixed solution was controlled to be 1200 ppm or less during the automatic production process as much as possible.

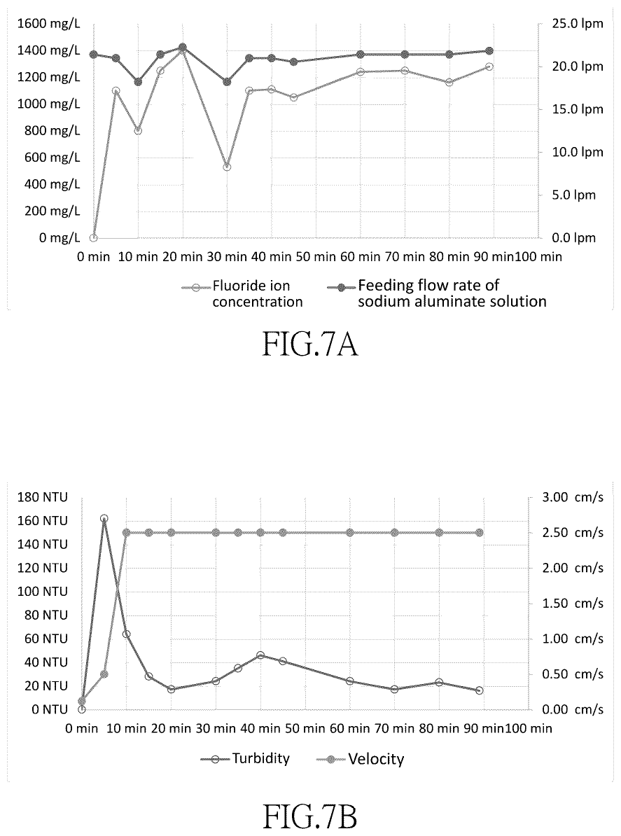

Specifically, in this example, the result of controlling the feeding flow rate of the sodium aluminate solution according to the actually detected in-situ parameter of the fluoride ion concentration in the induced crystallization reaction is shown in FIG. 7A. At the 5^{th} minute of continuous feeding of the sodium aluminate solution (the 4.5^{th} minute of continuous feeding of the hydrofluoric acid waste solution), the in-situ parameter of the fluoride ion concentration was detected to be 1100 ppm (equivalent to a 10% to 20% decrease in the targeted concentration), so the feeding flow rate of the sodium aluminate solution was controlled to be reduced to 21.0 lpm by the automatic control module 60; at the 10^{th} minute of continuous feeding of the sodium aluminate solution, the in-situ parameter of the fluoride ion concentration was detected to be 800 ppm (equivalent to lower than 30% below the targeted concentration), so the feeding flow rate of the sodium aluminate solution was controlled to be approximately 18.2 lpm by the automatic control module 60; at the 30^{th} minute of continuous feeding of the sodium aluminate solution, the in-situ parameter of the fluoride ion concentration was lower than 500 ppm (equivalent to lower than 30% below the targeted concentration but still higher than the limit concentration), so the feeding flow rate of the sodium aluminate solution was controlled to be approximately 18.2 lpm by the automatic control module 60; the detected in-situ parameters of the fluoride ion concentration and the results of controlling the feeding flow rate of the sodium aluminate solution at the remaining time are shown in FIG. 7A.

TABLE 5
The feeding flow rate of the sodium aluminate solution controlled
by the automatic control module according to the in-situ
parameter of the fluoride ion concentration of the mixed
solution in the reaction area in example 3

| In-situ parameter of | | Feeding flow rate | |
|---|---|---|---|
| the fluoride ion | | of the sodium | |
| concentration ([F⁻], ppm) | | aluminate solution (lpm) | |
| Higher than 30% | [F⁻] > 1560 | 15% above the | 21.4 + 3.21 |
| above the | | predetermined | |
| targeted | | flow rate | |
| concentration | | | |
| 20%~30% above | 1440 < [F⁻] ≤ 1560 | 8% above the | 21.4 + 1.712 |
| the targeted | | predetermined | |
| concentration | | flow rate | |
| 10%~20% above | 1320 < [F⁻] ≤ 1440 | 4% above the | 21.4 + 0.856 |
| the targeted | | predetermined | |
| concentration | | flow rate | |
| 5%~10% above | 1260 < [F⁻] ≤ 1320 | 2% above the | 21.4 + 0.428 |
| the targeted | | predetermined | |
| concentration | | flow rate | |
| Within 5% above | 1200 < [F⁻] ≤ 1260 | Predetermined | 21.4 |
| the targeted | | flow rate | |
| concentration | | | |
| Targeted | 1200 | Predetermined | 21.4 |
| concentration | | flow rate | |
| Within 5% below | 1140 ≤ [F⁻] < 1200 | Predetermined | 21.4 |
| the targeted | | flow rate | |
| concentration | | | |
| 5%~10% below | 1080 ≤ [F⁻] < 1140 | 2% below the | 21.4 − 0.428 |
| the targeted | | predetermined | |
| concentration | | flow rate | |
| 10%~20% below | 960 ≤ [F⁻] < 1080 | 4% below the | 21.4 − 0.856 |
| the targeted | | predetermined | |
| concentration | | flow rate | |
| 20%~30% below | 840 ≤ [F⁻] < 960 | 8% below the | 21.4 − 1.712 |
| the targeted | | predetermined | |
| concentration | | flow rate | |
| Lower than 30% | [F⁻] < 840 | 15% below the | 21.4 − 3.21 |
| below the | | predetermined | |
| targeted | | flow rate | |
| concentration | | | |
| Lower than | [F⁻] < 500 | Stop feeding | 0 |
| the limit | | | |
| concentration | | | |

During the first 5 minutes after the sodium aluminate solution started to be fed, the upflow velocity of the solution containing the self-assembled carrier in the confluence area A2 was 0.144 cm/s. At the 5^{th} minute after the sodium aluminate solution started to be fed, the actual detected in-situ turbidity parameter received by the automatic control module 60 was 160 NTU. The upflow velocity of the solution containing the self-assembled carrier extracted from the confluence area A2 flowing through the drain tube 51 to the reaction area A1 was controlled by the automatic control module 60 to be 0.50 cm/s based on the in-situ turbidity parameter, and the crystal nucleus of the confluence area A2 started to be guided to the reaction area A1. When the in-situ turbidity parameter received by the automatic control module 60 was lower than 100 NTU, the upflow velocity of the solution containing the self-assembled carrier in the confluence area A2 was increased by the automatic control module 60 at an increasing rate of 0.5 cm/s per minute, and the upflow velocity was controlled to rise to 2.50 cm/s, thereby making the crystals grown to the targeted particle size gradually precipitate to the crystal collection area A3, so as to facilitate the subsequent deposition of the sodium fluoroaluminate crystals in the crystal collection area A3 into a quicksand-like accumulation. The result of controlling the upflow velocity of the solution containing the self-organizing carrier in the confluence area A2 by the automatic control module 60 according to the received in-situ turbidity parameter is shown in FIG. 7B.

The total reaction time of example 3 was 90 minutes. During the reaction, the feeding flow rate of the hydrofluoric acid waste solution was fixed, the feeding flow rate of the sodium aluminate solution was controlled by the automatic control module 60 in real time according to the detected in-situ parameter of the fluoride ion concentration, and the upflow velocity of the solution containing the self-assembled carrier in the confluence area A2 was controlled according to the detected in-situ turbidity parameter. In this example, at the 10^{th} minute during feeding, the optical fiber sensor 19 detected for the first time that the sodium fluoroaluminate crystals had accumulated to a predetermined height on the guiding board 15. The discharging pump 42 of the crystal treatment module 40 was accordingly controlled to open by the automatic control module 60, so that the solution containing the sodium fluoroaluminate crystals (in-situ fluoride ion concentration of 980 ppm, in-situ turbidity of 26 NTU) flew from the crystal outlet 14 through the discharging tube 41 and was discharged to the centrifuge device 43. After the solution containing the sodium fluoroaluminate crystals was centrifuged and dehydrated by the centrifuge device 43, about 1150 kg of a sodium fluoroaluminate crystalline product (cryolite) could be obtained. The sodium fluoroaluminate crystalline product could be stored in the product collection tank 44. After the 1150 kg of the sodium fluoroaluminate crystalline product was dried, 1087 kg of a dry product with a moisture content of about 5.7% could be obtained.

Analyzed by filtering particle size, the dry product with a particle size larger than 200 mesh accounted for about 79% to 83%. Tested with the same method as in the previous example 1, the proportions of fluorine, sodium, and aluminum were respectively 51.66 wt %, 31.66 wt %, and 12.79 wt %, and the average sodium-to-aluminum molecular ratio was 2.91. The specific testing results are shown in Table 6. The testing results confirm that example 3 can indeed produce a sand-like, high-quality sodium fluoroaluminate crystalline product with a high molecular ratio.

TABLE 6
The results of analyzing the fluorine, sodium, and aluminum components
of the sodium fluoroaluminate crystalline product in example 3

| | | | | Sodium-to-aluminum |
|---|---|---|---|---|
| | Fluorine | Sodium | Aluminum | molecular ratio |
| | (wt %) | (wt %) | (wt %) | (mol/mol) |
| 1 | 51.24 | 31.76 | 12.65 | 2.95 |
| 2 | 51.58 | 31.43 | 12.88 | 2.86 |
| 3 | 51.66 | 31.66 | 12.79 | 2.91 |
| Average | 51.49 | 31.62 | 12.77 | 2.91 |

The above testing results confirm that the automatic method for producing sodium fluoroaluminate from an automatic system in example 3 can indeed recycle the high-concentration hydrofluoric acid waste solution into cryolites with high economic value. Specifically, in example 3, the high-concentration hydrofluoric acid waste solution (235.6 g/L) was processed into a solution with a fluoride ion concentration of about 980 ppm via the automatic method, and the removal rate was as high as 99.6%.

Based on the above examples 1 to 3, in the present invention, the automatic method can be performed for producing sodium fluoroaluminate from the automatic system, and the fluoride ions in high-concentration hydrofluoric acid waste solution can be efficiently recycled and reused through the automatic method, with a removal rate of 98% or above. Moreover, the sodium fluoroaluminate crystals with a particle size greater than 200 mesh (greater than 74 μm) in the final dry product account for 80% or above.

### Test Example 1

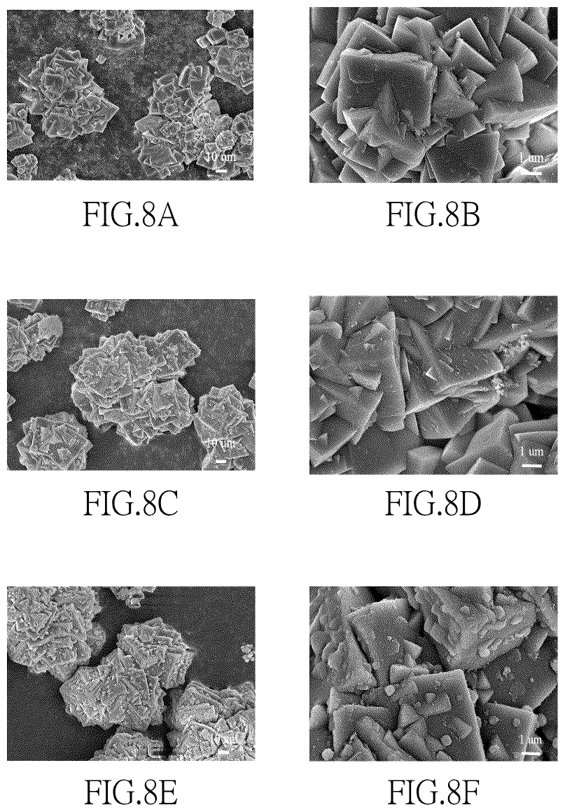

The sodium fluoroaluminate crystalline products of examples 1 to 3 were observed using a scanning electron microscope (SEM), and the results are shown in FIG. 8A to FIG. 8F. As shown in FIG. 8A to FIG. 8F, the microstructures of the sodium fluoroaluminate crystalline products of examples 1 to 3 all have a high-purity crystalline phase.

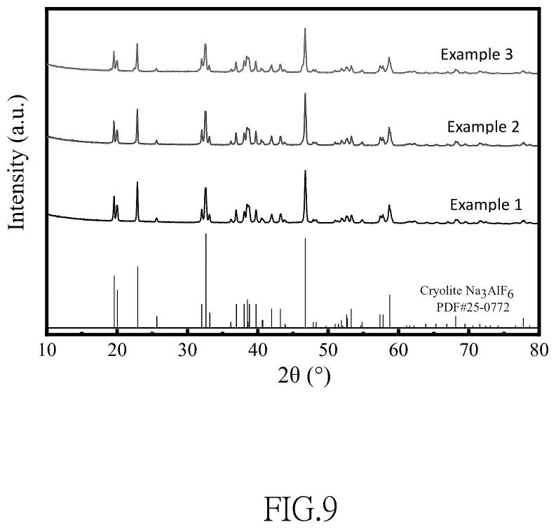

In addition, the crystal structures of the sodium fluoroaluminate crystalline products of examples 1 to 3 were identified by X-ray diffractometer (XRD), and the results are shown in FIG. 9. As shown in FIG. 9, by comparing the XRD analysis results of the sodium fluoroaluminate crystalline products of examples 1 to 3 with the XRD figure of a sodium fluoroaluminate (Na₃AlF₆) standard sample (PDF25-0772), it can be determined that the sodium fluoroaluminate crystalline products of examples 1 to 3 have monoclinic crystal structures.

The above SEM and XRD analysis results show that the XRD identification results are the same as the SEM microstructures, proving that the automatic method can be performed for producing sodium fluoroaluminate from the automatic system in the present invention, which can indeed efficiently reuse the hydrofluoric acid waste solutions and produce it into high-purity sodium fluoroaluminate crystalline products.

### Example 4: Automatically Producing Sodium Fluorosilicate Crystalline Product from the Hydrofluoric Acid Solution

In this example, a hydrofluoric acid waste solution recovered from manufacturer C was used as a material. The hydrofluoric acid waste solution was continuously fed into the lower part of the inner tank 12 of the crystallization device 10, the sodium silicate solution was continuously fed into the upper part of the inner tank 12 of the crystallization device 10, and the sodium fluorosilicate crystalline product was obtained with a simple process from the automatic method described below. The specific implementation is illustrated below corresponding to FIG. 2 to FIG. 4.

First, the hydrofluoric acid waste solution stored in the second feeding tank 31 of the second feeding module 30 was provided, the concentration of the hydrofluoric acid waste solution in the second feeding module 30 was analyzed to be 160.4 g/L, and the concentration parameter was sent to the automatic control module 60. In addition, the feeding flow rate of the hydrofluoric acid waste solution into the reaction area A1 was preset to be 40 lpm.

On the other hand, a sodium silicate solution was prepared and stored in the first feeding tank 21 of the first feeding module 20. The predetermined concentration of the sodium silicate solution was: the silicon ion concentration was 160.0 g/L, and the sodium ion concentration was 270.0 g/L. The predetermined concentration parameters were input into the automatic control module 60. A predetermined parameter of the flow rate of the sodium silicate solution was calculated and output by the automatic control module 60 according to the reaction formula and theoretical basis, thereby completing the preparation work before inducing the crystallization reaction. Herein, the fluoride ion concentration parameter of the hydrofluoric acid waste solution measured from the concentration analysis was received by the automatic control module 60, the predetermined flow rate parameter of the sodium silicate solution was calculated and output to the second pump 34 via 160.4*30÷19÷6×28÷160×1.03=7.6 according to the fluoride ion concentration parameter and the feeding flow rate of the hydrofluoric acid waste solution and the predetermined concentration of the sodium silicate solution, so that the sodium silicate solution was controlled to be continuously fed into the reaction area A1 initially at a predetermined flow rate of 7.6 lpm.

Before the hydrofluoric acid waste solution and the sodium silicate solution were continuously fed, clear water may be fed into the inner tank 12 of the crystallization device 10 to make the surface level of the clear water about 5 cm higher than the first feeding tube 22. Afterwards, the first pump 24 was controlled by the automatic control module 60 based on the aforementioned parameter of the output predetermined flow rate of the sodium silicate solution, making the sodium silicate solution in the first feeding tank 21 flow through the first feeding tube 22 and the spray nozzles 23 in advance and continuously fed into the upper part of the reaction area A1 by spraying at the predetermined flow rate of 7.6 lpm for 30 seconds. Hereafter, the second pump 34 was controlled by the automatic control module 60, making the hydrofluoric acid waste solution in the second feeding tank 31 flow through the second feeding tube 32 and the spray nozzles 33 and continuously fed into the lower part of the reaction area A1 at the feeding flow rate of 30 lpm by spraying, in order to form a mixed solution comprising the sodium silicate solution and the hydrofluoric acid waste solution. The mixed solution in the reaction area A1 was continuously stirred evenly with the stirring unit 122 in the feeding process, and the stirring speed remains at 120 rpm in the entire process.

After the sodium silicate solution and the hydrofluoric acid waste solution were continuously fed into the inner tank 12 of the crystallization device 10 for a while, as shown in FIG. 3, after the hydrofluoric acid solution and the sodium silicate solution were fed, the mixed solution in the reaction area A1 may flow through the flowing outlet 121 into the confluence area A2 and downward through the settling outlet 131, merging into the crystal collection area A3 and causing the liquid level to rise slowly from the bottom of the outer tank 11 and to gradually approach the level of the suction end 511 of the drain tube 51. After the sodium silicate solution and the hydrofluoric acid waste solution were continuously fed, the liquid level slowly rose to be higher than the level of the suction end 511 of the drain tube 51, as shown in FIG. 4. At this time, the mixed solution may flow within the reaction area A1, the confluence area A2, and the crystal collection area A3.

After the continuous feeding of the sodium silicate solution and the hydrofluoric acid waste solution into the reaction area A1 of the inner tank 12 of the crystallization device 10, the fluoride ion concentration sensor 17 started to detect the in-situ parameter of the fluoride ion concentration of the mixed solution in the reaction area A1, and the in-situ parameter of the fluoride ion concentration was sent to the automatic control module 60 in real time. The in-situ parameter of the fluoride ion concentration from the fluoride ion concentration sensor 17 was received by the automatic control module 60 and the second pump 34 was controlled based on the detected in-situ parameter to adjust the feeding flow rate of the sodium silicate solution in real time, so that the in-situ parameter of the fluoride ion concentration of the mixed solution in the reaction area A1 was controlled to be the targeted crystal nucleation concentration (referred to as targeted concentration in Table 7 below) or less corresponding to the meta-stable area as much as possible, thereby facilitating the induction of the crystallization reaction. In this example, the targeted crystal nucleation concentration corresponding to the meta-stable area during the induced crystallization reaction was 2000 ppm. The detected in-situ parameter of the fluoride ion concentration was received by the automatic control module 60 in real time, and the feeding flow rate of the sodium silicate solution was controlled in real time according to the relationship between the in-situ parameter of the fluoride ion concentration and the feeding flow rate of the sodium silicate solution shown in Table 7 below, so that the in-situ fluoride ion concentration of the mixed solution was controlled to be 2000 ppm or less during the automatic production process as much as possible.

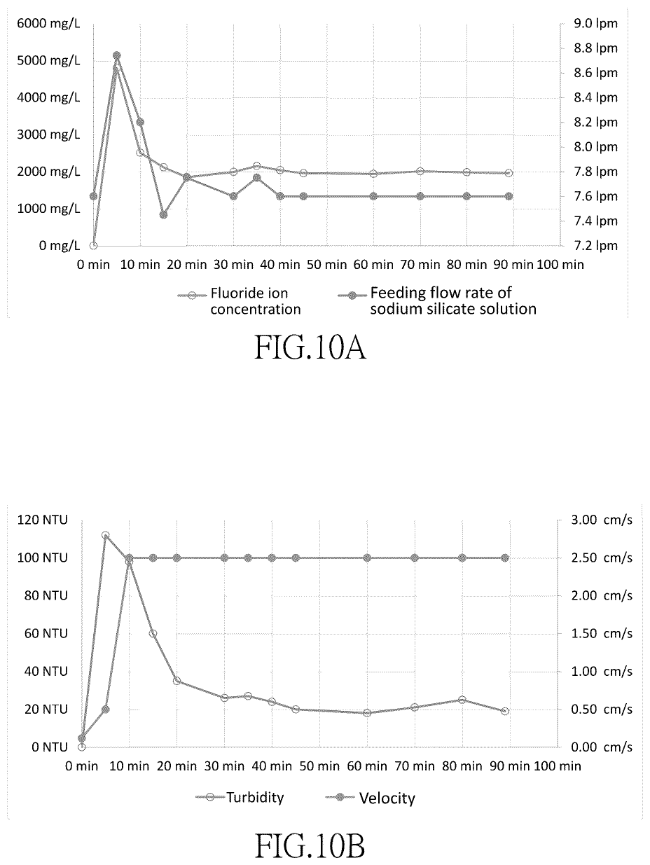

Specifically, in this example, the result of controlling the feeding flow rate of the sodium silicate solution according to the actually detected in-situ parameter of the fluoride ion concentration in the induced crystallization reaction is shown in FIG. 5A. At the 5^{th} minute of continuous feeding of the sodium silicate solution (the 4.5^{th} minute of continuous feeding of the hydrofluoric acid waste solution), the in-situ parameter of the fluoride ion concentration was detected to be 4800 ppm (equivalent to more than 30% above the targeted concentration), so the feeding flow rate of the sodium silicate solution was controlled to be approximately 8.7 lpm by the automatic control module 60; at the 10^{th} minute of continuous feeding of the sodium silicate solution, the in-situ parameter of the fluoride ion concentration was detected to be 2510 ppm (equivalent to a 20% to 30% increase in the targeted concentration), so the feeding flow rate of the sodium silicate solution was controlled to be approximately 8.2 lpm by the automatic control module 60; the detected in-situ parameters of the fluoride ion concentration and the results of controlling the feeding flow rate of the sodium silicate solution at the remaining time are shown in FIG. 10A.

TABLE 7
The feeding flow rate of the sodium silicate solution controlled
by the automatic control module according to the in-situ
parameter of the fluoride ion concentration of the mixed
solution in the reaction area in example 4

| In-situ parameter of | | Feeding flow rate | |
|---|---|---|---|
| the fluoride ion | | of the sodium | |
| concentration ([F⁻], ppm) | | silicate solution (lpm) | |
| Higher than 30% | [F⁻] > 2600 | 15% above the | 7.6 + 1.14 |
| above the | | predetermined | |
| targeted | | flow rate | |
| concentration | | | |
| 20%~30% above | 2400 < [F⁻] ≤ 2600 | 8% above the | 7.6 + 0.60 |
| the targeted | | predetermined | |
| concentration | | flow rate | |
| 10%~20% above | 2200 < [F⁻] ≤ 2400 | 4% above the | 7.6 + 0.30 |
| the targeted | | predetermined | |
| concentration | | flow rate | |
| 5%~10% above | 2100 < [F⁻] ≤ 2200 | 2% above the | 7.6 + 0.15 |
| the targeted | | predetermined | |
| concentration | | flow rate | |
| Within 5% above | 2000 < [F⁻] ≤ 2100 | Predetermined | 7.6 |
| the targeted | | flow rate | |
| concentration | | | |
| Targeted | 2000 | Predetermined | 7.6 |
| concentration | | flow rate | |
| Within 5% below | 1900 ≤ [F⁻] < 2000 | Predetermined | 7.6 |
| the targeted | | flow rate | |
| concentration | | | |
| 5%~10% below | 1800 ≤ [F⁻] < 1900 | 2% below the | 7.6 − 0.15 |
| the targeted | | predetermined | |
| concentration | | flow rate | |
| 10%~20% below | 1600 ≤ [F⁻] < 1800 | 4% below the | 7.6 − 0.30 |
| the targeted | | predetermined | |
| concentration | | flow rate | |
| 20%~30% below | 1400 ≤ [F⁻] < 1600 | 8% below the | 7.6 − 0.6 |
| the targeted | | predetermined | |
| concentration | | flow rate | |
| Lower than 30% | [F⁻] < 1400 | 15% below the | 7.6 − 1.14 |
| below the | | predetermined | |
| targeted | | flow rate | |
| concentration | | | |
| Lower than | [F⁻] < 1000 | Stop feeding | 0 |
| the limit | | | |
| concentration | | | |

After the 5^{th} minute of feeding the sodium silicate solution, the liquid level reached to be higher than the height of the suction end 511 of the drain tube 51 and the sensing end of the turbidity sensor 18. At this time, the in-situ fluoride ion concentration of the mixed solution in the reaction area A1 was not only detected in real time with the fluoride ion concentration sensor 17, but the turbidity of the carrier-containing solution in the confluence area A2 was also detected in real time when the sodium aluminate solution and the hydrofluoric acid solution were continuously fed and the crystallization reaction was induced. The in-situ turbidity parameter detected by the turbidity sensor 18 was received and the supply pump 52 of the carrier circulation module 50 was controlled according to the in-situ turbidity parameter by the automatic control module 60, so that the flow rate of the carrier-containing solution in the confluence area A2 absorbed from the suction end 511 guided back to the reaction area A1 was controlled in real time, in order to adjust the upflow velocity of the carrier-containing solution in the confluence area A2, facilitating the induction of the crystallization reaction.

Specifically, during the first 5 minutes after the sodium silicate solution started to be fed, the liquid level hadn't reached the sensing end of the turbidity sensor meter 18 yet, and the automatic control module 60 hadn't received the in-situ turbidity parameter and controlled the supply pump 52 yet. At this time, the upflow velocity of the solution containing the self-assembled carrier in the confluence area was 0.11 cm/s. At the 5^{th} minute after the sodium silicate solution started to be fed, the actual detected in-situ turbidity parameter received by the automatic control module 60 was higher than 100 NTU. The upflow velocity in the confluence area was controlled to be 0.50 cm/s by the automatic control module 60, and the suspended seed crystals were lifted at a low flow rate and guided back to the reaction area to continue growing. When the in-situ turbidity parameter received by the automatic control module 60 was lower than 100 NTU, meaning that the particle size had grown to a certain extent, so that the upflow velocity in the confluence area was increased at an increasing rate of 0.5 cm/s per minute by the automatic control module 60, and the upflow velocity in the confluence area was controlled to rise to 2.50 cm/s, thereby making the crystals grown to the targeted particle size gradually precipitate to the crystal collection area A3, so as to facilitate the subsequent deposition of the sodium fluorosilicate crystals in the crystal collection area A3 into a quicksand-like accumulation. The result of controlling the upflow velocity in the confluence area by the automatic control module 60 according to the received in-situ turbidity parameter is shown in FIG. 10B.

Besides, with the optical fiber sensor 19 installed below the settling funnel 13 and a certain distance higher than the crystal outlet 14, the sodium fluorosilicate crystals precipitated on the guiding board 15 of the crystal collection area A3 after reaction were detected in real time, and whether to discharge the solution containing the sodium fluorosilicate crystals was controlled by the automatic control module 60 according to whether the sodium fluorosilicate crystals reach a predetermined height.

It can be known herein that FIG. 10A and FIG. 10B only show the data of adjusting the feeding flow rate of the sodium silicate solution according to the in-situ parameter of the fluoride ion concentration detected every 5 minutes and adjusting the upflow velocity of the solution containing the self-assembled carrier in the confluence area according to the in-situ turbidity parameter detected every 5 minutes. The frequency of the detecting and the controlling was not particularly limited, and a person skilled in the art can adjust the frequency of sensing the in-situ fluoride ion concentration and controlling the feeding flow rate as needed.

The total reaction time of example 4 was 90 minutes. During the reaction, the feeding flow rate of the hydrofluoric acid waste solution was fixed, the feeding flow rate of the sodium silicate solution was controlled by the automatic control module 60 in real time according to the detected in-situ parameter of the fluoride ion concentration, and the upflow velocity of the solution containing the self-assembled carrier in the confluence area was controlled according to the detected in-situ turbidity parameter. In this example, at the 40^{th} minute during feeding, the optical fiber sensor 19 detected for the first time that the sodium fluorosilicate crystals had accumulated to a predetermined height on the guiding board 15. At 1 atm, the discharging pump 42 of the crystal treatment module 40 was controlled by the automatic control module 60 to open, so that the solution containing the sodium fluorosilicate crystals (in-situ fluoride ion concentration of 2040 ppm, in-situ turbidity of 24 NTU) flew from the crystal outlet 14 through the discharging tube 41 and was discharged to the centrifuge device 43. After the solution containing the sodium fluorosilicate crystals was centrifuged and dehydrated by the centrifuge device 43, about 705 kg of a sodium fluorosilicate crystalline product could be obtained. The sodium fluorosilicate crystalline product could be stored in the product collection tank 44. After the 705 kg of the sodium fluorosilicate crystalline product was dried, 672 kg of a dry product with a moisture content of about 4.7% could be obtained.

Analyzed by filtering particle size, the dry product with a particle size larger than 140 mesh accounted for about 76% to 81%. The purity testing was further performed using American Water Works Association (AWWA) B702:2018. After the sodium fluorosilicate crystalline products were randomly sampled for three times in the purity testing using the AWWA method above, the purities were respectively found to be 99.89 wt %, 99.95 wt %, and 99.88 wt % after averaged in the analysis, and the average purity was 99.91%. The testing results confirm that example 4 can indeed produce a sand-like, high-quality sodium fluorosilicate crystalline product with a high purity.

The above testing results confirm that the automatic method for producing sodium fluorosilicate from an automatic system in example 4 can indeed recycle the high-concentration hydrofluoric acid waste solution into sodium fluorosilicate crystalline products with high economic value. Specifically, in example 4, the high-concentration hydrofluoric acid waste solution (160.4 g/L) was processed into a solution with a fluoride ion concentration of about 2040 ppm via the automatic method, and the removal rate was as high as 98.7%.

### Test Example 2

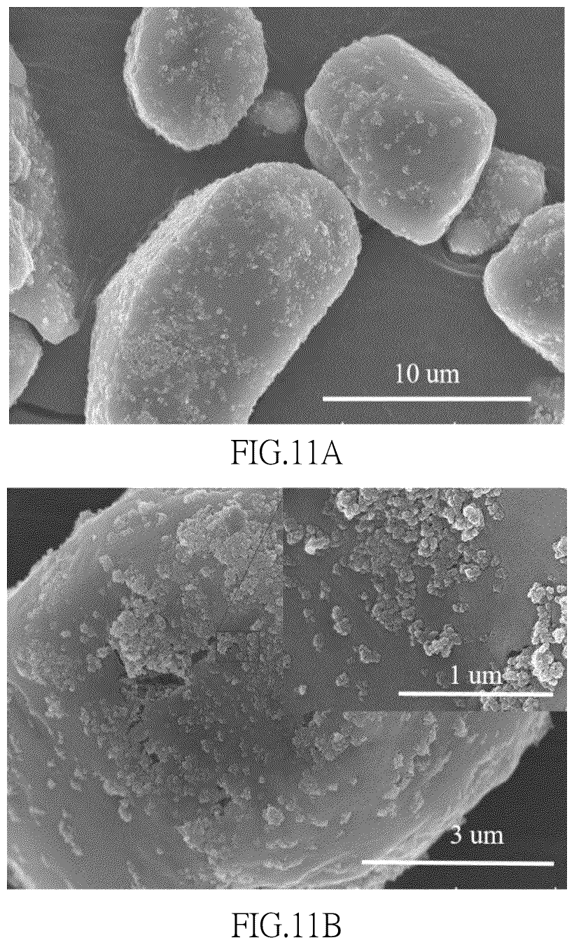

The sodium fluorosilicate crystalline product of example 4 was observed using the SEM, and the results are shown in FIG. 11A and FIG. 11B. As shown in FIG. 11A and FIG. 11B, the microstructures of the sodium fluorosilicate crystalline product of example 4 all have a high-purity crystalline phase.

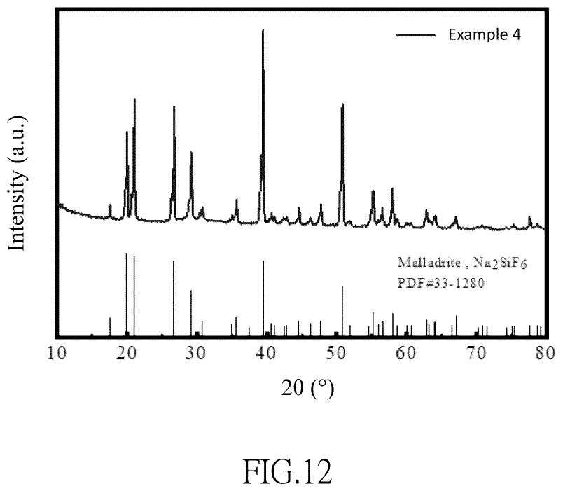

In addition, the crystal structures of the sodium fluorosilicate crystalline product of example 4 were identified by the XRD, and the result is shown in FIG. 12. As shown in FIG. 12, by comparing the XRD analysis result of the sodium fluorosilicate crystalline product of example 4 with the XRD figure of a sodium fluorosilicate (Na₃SiF₆) standard sample (PDF33-1280), it can be determined that the sodium fluorosilicate crystalline product of example has hexagonal crystal structures.

The above SEM and XRD analysis results show that the XRD identification results are the same as the SEM microstructures, proving that the automatic method can be performed for producing sodium fluorosilicate from the automatic system in the present invention, which can indeed efficiently reuse the hydrofluoric acid waste solutions into high-purity sodium fluorosilicate crystalline products.

In summary, the hydrofluoric acid solution with a high concentration can be effectively reused, and the fluorine-containing crystalline product with high economic value can be produced with the simple and easy-to-control automatic skill. Furthermore, the invention is conducive to simplifying the complicated process of the existing technology, and the sodium fluoroaluminate crystalline products of high sodium-to-aluminum ratio or the sodium fluorosilicate crystalline products with sand-like shape and low moisture content can be successfully obtained.

What is claimed is:

1. An automatic method for producing a fluorine-containing crystalline product from a hydrofluoric acid solution, the method comprising:
providing the hydrofluoric acid solution and a reaction solution with a predetermined concentration, wherein the reaction solution is an aluminate solution or a silicate solution;
sensing a fluoride ion concentration of the hydrofluoric acid solution and presetting a feeding flow rate of the hydrofluoric acid solution;
outputting a predetermined flow rate of the reaction solution by an automatic control module based on the fluoride ion concentration and the feeding flow rate of the hydrofluoric acid solution and the predetermined concentration of the reaction solution;
feeding the reaction solution into a reaction area at the predetermined flow rate, and feeding the hydrofluoric acid solution into the reaction area at the feeding flow rate, so as to perform a crystallization reaction and form a mixed solution in the reaction area;
sensing a fluoride ion concentration of the mixed solution in the reaction area in real time while feeding the reaction solution and the hydrofluoric acid solution, receiving an in-situ parameter of the fluoride ion concentration of the mixed solution in the reaction area by the automatic control module, and controlling a feeding flow rate of the reaction solution in real time by the automatic control module under conditions that:
when the in-situ parameter of the fluoride ion concentration received by the automatic control module falls within a range of a targeted crystal nucleation concentration ±5%, the feeding flow rate of the reaction solution is controlled to be equal to the predetermined flow rate of the reaction solution;
when the in-situ parameter of the fluoride ion concentration is higher than 5% above the targeted crystal nucleation concentration, the feeding flow rate of the reaction solution is controlled to be greater than the predetermined flow rate of the reaction solution; and
when the in-situ parameter of the fluoride ion concentration is lower than 5% below the targeted crystal nucleation concentration, the feeding flow rate of the reaction solution is controlled to be less than the predetermined flow rate of the reaction solution;
sensing multiple fluorine-containing crystals produced by the crystallization reaction and precipitated to a crystal collection area in real time, and controlling whether to discharge a solution comprising the fluorine-containing crystals by the automatic control module based on whether the fluorine-containing crystals reach a predetermined height; and
collecting a fluorine-containing crystalline product from a solution comprising the fluorine-containing crystals.

2. The automatic method as claimed in claim 1, wherein the automatic method comprises: sensing a turbidity of a confluence area in real time, and receiving an in-situ turbidity parameter and controlling an upflow velocity of a carrier-containing solution in the confluence area in real time based on the in-situ turbidity parameter by the automatic control module, wherein the confluence area is located between and interconnected with the reaction area and the crystal collection area.

3. The automatic method as claimed in claim 2, wherein
when the in-situ turbidity parameter received by the automatic control module is higher than 100 NTU, the upflow velocity of the carrier-containing solution in the confluence area controlled by the automatic control module is 0.4 cm/s to 0.6 cm/s, and
when the in-situ turbidity parameter received by the automatic control module is lower than 100 NTU, the upflow velocity of the carrier-containing solution in the confluence area controlled by the automatic control module is 2.2 cm/s to 2.6 cm/s.

4. The automatic method as claimed in claim 1, wherein
when the in-situ parameter of the fluoride ion concentration of the mixed solution in the reaction area received by the automatic control module is 5% to 10% above the targeted crystal nucleation concentration, the feeding flow rate of the reaction solution is controlled by the automatic control module to be 1.5% to 2.5% above the predetermined flow rate of the reaction solution; when the in-situ parameter of the fluoride ion concentration of the mixed solution in the reaction area received by the automatic control module is 5% to 10% below the targeted crystal nucleation concentration, the feeding flow rate of the reaction solution is controlled by the automatic control module to be 1.5% to 2.5% below the predetermined flow rate of the reaction solution;
when the in-situ parameter of the fluoride ion concentration of the mixed solution in the reaction area received by the automatic control module is 10% to 20% above the targeted crystal nucleation concentration, the feeding flow rate of the reaction solution is controlled by the automatic control module to be 3.5% to 4.5% above the predetermined flow rate of the reaction solution; when the in-situ parameter of the fluoride ion concentration of the mixed solution in the reaction area received by the automatic control module is 10% to 20% below the targeted crystal nucleation concentration, the feeding flow rate of the reaction solution is controlled by the automatic control module to be 3.5% to 4.5% below the predetermined flow rate of the reaction solution;
when the in-situ parameter of the fluoride ion concentration of the mixed solution in the reaction area received by the automatic control module is 20% to 30% above the targeted crystal nucleation concentration, the feeding flow rate of the reaction solution is controlled by the automatic control module to be 7.5% to 8.5% above the predetermined flow rate of the reaction solution; when the in-situ parameter of the fluoride ion concentration of the mixed solution in the reaction area received by the automatic control module is 20% to 30% below the targeted crystal nucleation concentration, the feeding flow rate of the reaction solution is controlled by the automatic control module to be 7.5% to 8.5% below the predetermined flow rate of the reaction solution;
when the in-situ parameter of the fluoride ion concentration of the mixed solution in the reaction area received by the automatic control module is higher than 30% above the targeted crystal nucleation concentration, the feeding flow rate of the reaction solution is controlled by the automatic control module to be 14.5% to 15.5% above the predetermined flow rate of the reaction solution; when the in-situ parameter of the fluoride ion concentration of the mixed solution in the reaction area received by the automatic control module is lower than 30% below the targeted crystal nucleation concentration, the feeding flow rate of the reaction solution is controlled by the automatic control module to be at least 14.5% to 15.5% below the predetermined flow rate of the reaction solution.

5. The automatic method as claimed in claim 1, wherein the aluminate solution comprises a sodium aluminate solution, an aluminum sulfate solution containing a sodium source, a polyaluminum chloride solution containing a sodium source, or a combination thereof, wherein the sodium source comprises sodium hydroxide, sodium chloride, sodium nitrate, or any combinations thereof.

6. The automatic method as claimed in claim 1, wherein the silicate solution comprises a sodium silicate solution.

7. The automatic method as claimed in claim 1, wherein the hydrofluoric acid solution comprises hydrochloric acid, nitric acid, sulfuric acid, or any combinations thereof.

8. The automatic method as claimed in claim 1, wherein the targeted crystal nucleation concentration is 1000 ppm to 12000 ppm.

9. The automatic method as claimed in claim 1, wherein the automatic method comprises feeding water or a recycled carrier-containing solution into the reaction area in advance, feeding the reaction solution into the reaction area at the predetermined flow rate, and feeding the hydrofluoric acid solution into the reaction area at the feeding flow rate.

10. The automatic method as claimed in claim 1, wherein the step of collecting the fluorine-containing crystalline product from the solution comprising the fluorine-containing crystals comprises: centrifuging the solution comprising the fluorine-containing crystals to collect the fluorine-containing crystalline products.

11. The automatic method as claimed in claim 1, wherein the automatic method comprises: feeding the reaction solution into the reaction area by spraying, and feeding the hydrofluoric acid solution into the reaction area by spraying; the spray shapes of the reaction solution and the hydrofluoric acid solution are each independently the shape of a sector, hollow cone, solid cone, spiral, or cylinder.

12. The automatic method as claimed in claim 11, wherein one of the reaction solution and the hydrofluoric acid solution is sprayed into the shape of a sector or a solid cone and fed into an upper part of the reaction area, and the other of the reaction solution and the hydrofluoric acid solution is sprayed into the shape of a hollow cone or a spiral and fed into a lower part of the reaction area.

13. The automatic method as claimed in claim 1, wherein the concentration of the hydrofluoric acid solution is 10 g/L to 400 g/L.

14. The automatic method as claimed in claim 1, wherein when the reaction solution is the aluminate solution and the fluorine-containing crystalline product is a sodium fluoroaluminate crystalline product, a predetermined flow rate of the aluminate solution is output by the automatic control module according to the calculation that a ratio of the aluminum ion concentration of the aluminate solution to the fluoride ion concentration of the hydrofluoric acid solution is 1:6 to 1.20:6.

15. The automatic method as claimed in claim 1, wherein when the reaction solution is the silicate solution and the fluorine-containing crystalline product is a sodium fluorosilicate crystalline product, a predetermined flow rate of the sodium silicate solution is output by the automatic control module according to the calculation that a ratio of the silicon ion concentration of the sodium silicate solution to the fluoride ion concentration of the hydrofluoric acid solution is 1:6 to 1.20:6.
